(19) United States
(12) Patent Application Publication
(10) Pub. No.: US 2009/0005102 A1
(43) Pub. Date: Jan. 1, 2009

(54) Method and Apparatus for Dynamically Adjusting Base Station Transmit Power

(76) Inventors: Suman Das, Colonia, NJ (US); Thierry Etienne Klein, Fanwood, NJ (US); Harish Viswanathan, Morristown, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/772,142

(22) Filed: Jun. 30, 2007

(51) Int. Cl. H04B 7/005; H04Q 7/30

(52) U.S. Cl. 455/522

(57) ABSTRACT

The invention includes a method and apparatus for adjusting the transmit power of a base station. In one embodiment, the transmit power of a base station is adjusted using rate metrics. A method according to one embodiment includes adjusting a transmit power of a target base station based on a per-user rate metric associated with the target base station and at least one per-user rate metric associated with at least one other base station. The per-user rate metrics may be based on any base station metrics, such as average system throughput of the base station, aggregate cell capacity of the base station, and the like. The per-user rate metrics may be computed or estimated using feedback information from wireless user devices. In one embodiment, the transmit power of a base station is adjusted using other information, such as geographic distances between base station, signal strength measurements received at base stations from other base stations, and the like, as well as various combinations thereof. A method according to one embodiment includes obtaining non-feedback information and adjusting the transmit power of the base station using the non-feedback information.

### FIELD OF THE INVENTION

The invention relates to the field of communication networks and, more specifically, to wireless networks.

### BACKGROUND OF THE INVENTION

Emergency response organizations increasingly depend on wireless communication technology to provide communication during emergencies. Disadvantageously, however, emergencies often result in damage to, or sometimes even destruction of, existing network infrastructure, thereby preventing communications between emergency personnel. In other words, the existing communications infrastructure lacks survivability. Furthermore, even if portions of the existing communications infrastructure do survive the emergency, the existing communications infrastructure may not be able to handle the increased traffic load typical during emergencies. Specifically, remaining portions of the existing communication infrastructure may be overloaded as emergency personnel, and the general public, attempt various types of communications. Such deficiencies became clear during the events of Sep. 11, 2001, and again during the events of Hurricane Katrina.

In existing commercial cellular networks, deploying a base station to the field is a complex and time consuming process. First, the base station must be delivered to a location at which the base station is to be deployed. After being deployed at the location, network provider personnel must then activate and configure the base station. Specifically, the network provider personnel responsible for activating and configuring the base station must perform drive testing and signal strength measurements, and then run complex optimization algorithms in order to determine RF power setting updates. Furthermore, the network provider personnel must repeat this complex process until satisfied with the resulting RF power settings. This existing approach to base station RF power configuration is simply not feasible during an emergency where a network must be rapidly deployed at an emergency site.

### SUMMARY OF THE INVENTION

Various deficiencies in the prior art are addressed through the invention of a method and apparatus for adjusting the transmit power of a base station.

In one embodiment, in which feedback information from wireless user devices is available, the transmit power of a base station may be adjusted using rate metrics. A method according to one embodiment includes adjusting a transmit power of a target base station based on a per-user rate metric associated with the target base station and at least one per-user rate metric associated with at least one other base station. The per-user rate metrics may be based on any base station metrics, such as average system throughput of the base station, aggregate cell capacity of the base station, and the like. The per-user rate metrics may be determined using feedback information from wireless user devices, e.g., using one or more of data rate request information, channel state information, pilot signal strength measurement information, and the like, as well as various combinations thereof. Depending on the feedback information available, the transmit power of the base station may be adjusted by a predetermined amount of transmit power or by a computed amount of transmit power.

In one embodiment, in which feedback information from the wireless user devices is unavailable for use in adjusting the transmit power of a target base station (or is not yet available for use in adjusting the base station transmit power of the target base station), the base station transmit power of the target base station may be adjusted using other information, such as geographic distances between the target base station and one or more other base stations, signal strength measurements received at the target base station from one or more other base stations, and the like, as well as various combinations thereof. A method according to one embodiment includes obtaining information associated with the target base station and at least one other base station, and setting the transmit power of the base station using the obtained information.

### BRIEF DESCRIPTION OF THE DRAWINGS

The teachings of the present invention can be readily understood by considering the following detailed description in conjunction with the accompanying drawings, in which:

FIG. 1 depicts a standalone 911-NOW communication network architecture that is independent of any existing network infrastructure;

FIG. 2 depicts an integrated 911-NOW communication network architecture that utilizes a 911-NOW mesh network and an existing network infrastructure;

FIG. 3 depicts a high-level block diagram of one embodiment of a 911-NOW node;

FIG. 4 depicts a method according to one embodiment of the present invention;

FIG. 5 depicts a method according to one embodiment of the present invention;

FIG. 6 depicts a method according to one embodiment of the present invention;

FIG. 7 depicts a method according to one embodiment of the present invention;

FIG. 8 depicts a method according to one embodiment of the present invention;

FIG. 9 depicts a method according to one embodiment of the present invention;

FIG. 10 depicts a method according to one embodiment of the present invention; and

FIG. 11 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention is described within the context a rapidly deployable wireless network (denoted herein as a 911 network on wheels, i.e., 911-NOW); however, the present invention is applicable to RF transmit power adjustments performed in various other wireless networks that may or may not be rapidly deployable networks. A 911-NOW network is formed by placing a 911-NOW node(s) on a mobile platform(s) such that when the mobile platform(s) is dispatched to a network site, the 911-NOW node(s) provides a wireless communication network. As described herein, one or more 911-NOW nodes may be deployed to form a wireless network. The 911-NOW network may be a standalone wireless network that is independent of existing network infrastructure or an integrated wireless network that utilizes existing network infrastructure.

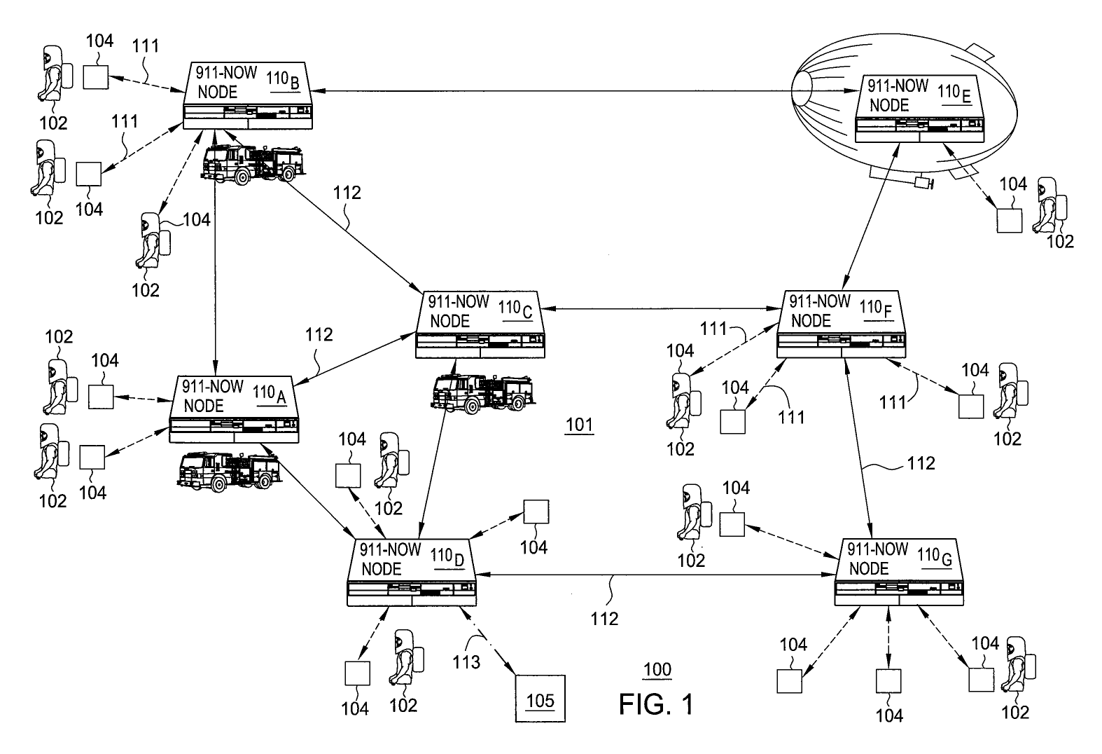

FIG. 1 depicts a standalone 911-NOW communication network architecture that is independent of any existing network infrastructure. Specifically, standalone 911-NOW communication network architecture 100 includes a plurality of 911-NOW nodes 110_{A}-110_{G} (collectively, 911-NOW nodes 110) supporting wireless communications at an emergency site 101. The standalone 911-NOW communication network architecture 100 provides a fully-functional network since each of the 911-NOW nodes 110 supports radio access network (RAN) functions, core networking functions, and services. As depicted in FIG. 1, each of the 911-NOW nodes 110 is placed or mounted on a mobile platform and transported to emergency site 101. The 911-NOW nodes 110 form a wireless network at emergency site 101.

The emergency site 101 may be any location or combination of locations at which a wireless network is required. The emergency site 101 may be a localized site, a collection of localized sites, a widespread site, a collection of widespread sites, and the like, as well as various combinations thereof. For example, emergency site 101 may be a single location, multiple locations within a town or city, or even span one or more counties, states, countries, or even continents. The 911-NOW network is not limited by the scope of the emergency site. The emergency site 101 may be associated with any type of emergency. For example, emergency site 101 may be associated with a natural disaster (e.g., a flood, a hurricane, a tornado, and the like), a manmade disaster (e.g., a chemical spill, a terrorist attack, and the like), and the like, as well as various combinations thereof.

As depicted in FIG. 1, emergency personnel (denoted herein as users 102 of the 911-NOW network 100) have responded to the emergency. The users 102 are performing various different functions at different areas of emergency site 101. For example, the users may be containing the disaster, participating in evacuation operations, participating in search and rescue operations, and the like, as well as various combinations thereof. The users 102 use equipment in responding to the emergency, including equipment capable of receiving and sending information wirelessly (denoted herein as wireless user devices 104 of users 102). The wireless user devices 104 include communication equipment, and may include various other types of emergency equipment (depending on the type of emergency, severity of the emergency, logistics of the emergency site, and various other factors).

For example, wireless user devices 104 may include wireless devices carried by emergency personnel for communicating with other emergency personnel, receiving information for use in responding at the emergency site, collecting information at the emergency site, monitoring conditions at the emergency site, and the like, as well as various combinations thereof. For example, wireless user devices 104 may include devices such as walkie-talkies, wireless headsets, cell phones, personal digital assistants (PDAs), laptops, and the like, as well as various combinations thereof. The wireless user devices 104 may include various other equipment, such as monitors (e.g., for monitoring breathing, pulse, and other characteristics; for monitoring temperature, precipitation, and other environmental characteristics; and the like), sensors (e.g., for detecting air-quality changes, presence of chemical or biological agents, radiation levels, and the like), and various other equipment.

As depicted in FIG. 1, a 911-NOW-based network is established at the emergency site 101 by deploying 911-NOW nodes 110 (illustratively, 911-NOW nodes 110_{A}-110_{G}) to emergency site 101. The 911-NOW nodes 110 may be deployed using mobile platforms. The 911-NOW nodes 110 may be deployed using standalone mobile platforms. For example, 911-NOW nodes 110 may be placed in backpacks, suitcases, and like mobile cases which may be carried by individuals. The 911-NOW nodes 110 may be deployed using mobile vehicles, including land-based vehicles, sea-based vehicles, and/or air-based vehicles. For example, 911-NOW nodes may be placed (and/or mounted) on police cars, swat trucks, fire engines, ambulances, humvees, boats, helicopters, blimps, airplanes, unmanned drones, satellites, and the like, as well as various combinations thereof. The 911-NOW nodes 110 may be deployed using various other mobile platforms.

As depicted in FIG. 1, 911-NOW node 110_{A} is deployed using a fire engine, 911-NOW node 110_{B} is deployed using a fire engine, 911-NOW node 110_{C} is deployed using a fire engine, 911-NOW node 110_{D} is deployed as a standalone node, 911-NOW node 110_{E} is deployed using a blimp, 911-NOW node 110_{F} is deployed as a standalone node, and 911-NOW node 110_{G} is deployed using a fire engine. The inherent mobility of 911-NOW nodes 110 enables quick and flexible deployment of a wireless network as needed (e.g., when, where, and how the wireless network is needed), thereby providing scalable capacity and coverage on-demand as required by the emergency personnel. Since each 911-NOW node 110 supports RAN functions, core networking functions, and various services, deployment of even one 911-NOW node produces a fully-functional wireless network.

As depicted in FIG. 1, the 911-NOW nodes 110 support wireless communications for wireless user devices 104 (denoted herein as wireless access communications). The wireless access communications include wireless communications between a 911-NOW node 110 and wireless user devices served by that 911-NOW node 110. A 911-NOW node 110 includes one or more wireless access interfaces supporting wireless communications for wireless user devices 104 using respective wireless access connections 111 established between wireless user devices 104 and 911-NOW nodes 110. The 911-NOW nodes 110 further support mobility of user devices 104 at emergency site 101 such that, as users 102 move around emergency site 101, communication sessions between wireless user devices 104 of those users 102 and 911-NOW nodes 110 are seamlessly transferred between 911-NOW nodes 110.

As depicted in FIG. 1, the 911-NOW nodes 110 support wireless communications between 911-NOW nodes 110 (denoted herein as wireless mesh communications). The wireless mesh communications include wireless communications between 911-NOW nodes, including information transported between wireless user devices 104, control information exchanged between 911-NOW nodes 110, and the like, as well as various combinations thereof. A 911-NOW node 110 includes one or more wireless mesh interfaces supporting wireless communications with one or more other 911-NOW nodes 110. The wireless mesh communications between 911-NOW nodes 110 are supported using wireless mesh connections 112 established between 911-NOW nodes 110.

As depicted in FIG. 1, the following pairs of 911-NOW nodes 110 communicate using respective wireless mesh connections 112: 911-NOW nodes 110_{A} and 110_{B}, 911-NOW nodes 110_{A} and 110_{C}, 911-NOW nodes 110_{A} and 110_{D}, 911-NOW nodes 110_{B} and 110_{C}, 911-NOW nodes 110_{C} and 110_{D}, 911-NOW nodes 110_{B} and 110_{E}, 911-NOW nodes 110_{C} and 110_{F}, 911-NOW nodes 110_{D} and 110_{G}, 911-NOW nodes 110_{E} and 110_{F}, and 911-NOW nodes 110_{F} and 110_{G}. As such, 911-NOW nodes 110 of FIG. 1 communicate to form a wireless mesh network. Although a specific wireless mesh configuration is depicted and described with respect to FIG. 1, 911-NOW nodes 110 may communicate to form various other wireless mesh configurations, and mesh configurations may be modified in real-time as conditions change.

As depicted in FIG. 1, the 911-NOW nodes 110 support wireless communications for one or more management devices 105 (denoted herein as wireless management communications). The wireless management communications include wireless communications between a 911-NOW node 110 and a management device(s) 105 served by that 911-NOW node 110. A 911-NOW node 110 includes one or more wireless management interfaces supporting wireless communications for management device(s) 105. The wireless management communications between management device 105 and 911-NOW node 110_{D} are supported using a wireless management connection 113 established between management device 105 and 911-NOW node 110_{D}.

The management device 105 is operable for configuring and controlling standalone 911-NOW network 100. For example, management device 105 may be used to configure and reconfigure one or more of the 911-NOW nodes 110, control access to the 911-NOW nodes, control functions and services supported by the 911-NOW nodes 110, upgrade 911-NOW nodes 110, perform element/network management functions for individual 911-NOW nodes or combinations of 911-NOW nodes (e.g., fault, performance, and like management functions) and the like, as well as various combinations thereof. The management device 105 may be implemented using existing devices (e.g., laptops, PDAs, and the like), or using a newly-designed device adapted to support such management functions. The management device 105 may connect to one or more 911-NOW nodes 110 directly and/or indirectly using wireline and/or wireless interfaces.

The 911-NOW nodes 110 support wireless communications using one or more wireless technologies. For wireless access communications, each 911-NOW node 110 may support one or more different wireless technologies, such as Global System for Mobile Communications (GSM), General Packet Radio Service (GPRS), Evolution—Data Optimized (1xEV-DO), Universal Mobile Telecommunications System (UMTS), High-Speed Downlink Packet Access (HSDPA), Worldwide Interoperability for Microwave Access (WiMAX), and the like. For wireless mesh communications, each 911-NOW node 110 may support Wireless Fidelity (WiFi) or WiMAX technology, microwave technologies, or any other wireless technology. For wireless management communications, each 911-NOW node 110 may support one or more such cellular technologies, and, further, may support WiFi technology, Bluetooth technology, or any other wireless technology.

The wireless communications supported by 911-NOW nodes 110 convey user information, control information, and the like, as well as various combinations thereof. For example, user information may include voice communications (e.g., voice calls, audio conferences, push-to-talk, and the like), data communications (e.g., text-based communications, high-speed data downloads/uploads, file transfers, and the like), video communications (e.g., video broadcasts, conferencing, and the like), multimedia communications, and the like, as well as various combinations thereof. The communications supported by 911-NOW nodes 110 may convey various combinations of content, e.g., audio, text, image, video, multimedia, and the like, as well as various combinations thereof. For example, control information may include network configuration information, network control information, management information and the like, as well as various combinations thereof. Thus, 911-NOW nodes 110 support wireless communication of any information.

Although a specific number of 911-NOW nodes 110 is depicted and described as being deployed to form a 911-NOW network, fewer or more 911-NOW nodes may be deployed to form a 911-NOW network supporting communications required to provide an effective emergency response. Similarly, although a specific configuration of 911-NOW nodes 110 is depicted and described as being deployed to form a 911-NOW network, 911-NOW nodes may be deployed in various other configurations (including different locations at one emergency site or across multiple emergency sites, different combinations of mesh connections between 911-NOW nodes, and the like, as well as various combinations thereof) to form a standalone 911-NOW network supporting RAN functions, CORE networking functions, and various services supporting multimedia communications to provide an effective emergency response.

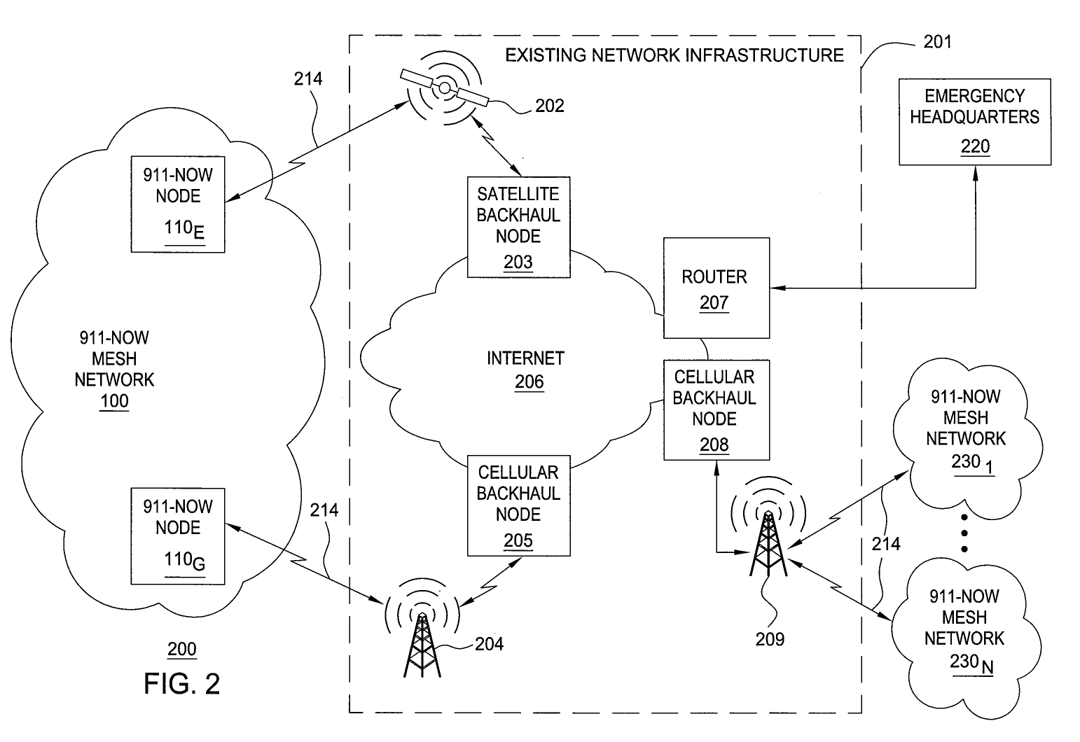

As described herein, although one or more 911-NOW nodes 110 are capable of forming a fully-functional standalone mesh wireless network without relying on existing infrastructure (fixed or variable), where there is existing infrastructure (that was not damaged or destroyed), the standalone 911-NOW wireless network may leverage the existing network infrastructure to form an integrated 911-NOW wireless network capable of supporting various additional capabilities (e.g., supporting communications with one or more other standalone 911-NOW wireless networks, supporting communications with one or more remote emergency management headquarters, supporting communications with other resources, and the like, as well as various combinations thereof). An integrated 911-NOW wireless network including a mesh 911-NOW network in communication with existing network infrastructure is depicted and described herein with respect to FIG. 2.

FIG. 2 depicts an integrated 911-NOW communication network architecture including a 911-NOW mesh network and an existing network infrastructure. Specifically, the integrated 911-NOW communication network architecture 200 includes 911-NOW mesh network 100 (depicted and described with respect to FIG. 1) and existing network infrastructure 201. The existing network infrastructure 201 may include any existing communications infrastructure adapted for supporting communications for 911-NOW mesh network 100 (e.g., including wireless communications capabilities, backhaul functions, networking functions, services, and the like, as well as various combinations thereof).

The existing network infrastructure 201 may include wireless access capabilities (e.g., radio access networks, satellite access networks, and the like, as well as various combinations thereof), backhaul capabilities (e.g., public and/or private, wireline and/or wireless, backhaul networks supporting mobility management functions, routing functions, and gateway functions, as well as various other related functions), core networking capabilities (e.g., AAA functions, DNS functions, DHCP functions, call/session control functions, and the like), services capabilities (e.g., application servers, media servers, and the like), and the like, as well as various combinations thereof. Since 911-NOW nodes 110 also supports such capabilities, in some embodiments at least a portion of these capabilities of existing network infrastructure 201 may only be relied upon when necessary.

As depicted in FIG. 2, the existing network infrastructure 201 supports wireless backhaul connections. Specifically, the existing network infrastructure 201 supports two wireless backhaul connections from 911-NOW mesh network 100. The existing network infrastructure 201 supports a first wireless backhaul connection 214 with 911-NOW node 110_{E} using a satellite 202, where satellite 202 is in wireless backhaul communication with a satellite backhaul node 203 at the edge of Internet 206. The existing network infrastructure 201 supports a second wireless backhaul connection 214 with 911-NOW node 110_{G} using a cellular base station 204, where cellular base station in 204 is in wireline backhaul communication with a cellular backhaul node 205 at the edge of Internet 206.

As depicted in FIG. 2, the existing network infrastructure 201 further supports other connections to other locations with which users 102 of emergency site 101 may communicate. The existing network infrastructure 201 includes a router 207 supporting communications for an emergency headquarters 220 (which may include, for example, emergency personnel and/or emergency systems). The existing network infrastructure 201 includes a cellular backhaul node 208 and an associated base station 209 supporting communications for one or more other 911-NOW mesh networks 230₁-230_{N} (i.e., one or more other standalone 911-NOW networks established at remote emergency sites).

The existing network infrastructure 201 supports communications for 911-NOW mesh network 100. The existing network infrastructure 201 may support communications between wireless user devices 104 of 911-NOW mesh network 100 (e.g., complementing wireless mesh communications between 911-NOW nodes 110 of the standalone 911-NOW network 100). The existing network infrastructure 201 may support communications between wireless user devices 104 of 911-NOW mesh network 100 and other emergency personnel and/or emergency systems. For example, existing network infrastructure 201 may support communications between wireless user devices 104 of 911-NOW mesh network 100 and an emergency headquarters 220, one or more other 911-NOW mesh networks 230 (e.g., at emergency sites remote from emergency site 101), and the like, as well as various combinations thereof.

As depicted in FIG. 2, in addition to supporting one or more wireless access interfaces, one or more wireless mesh interfaces, and one or more wireless management interfaces, 911-NOW nodes 110 support one or more wireless backhaul interfaces supporting communications between 911-NOW nodes 110 and existing network infrastructure (illustratively, existing network infrastructure 201). The wireless backhaul communications between 911-NOW nodes 110 and existing network infrastructure 201 are supported using wireless backhaul connections 214 established between 911-NOW nodes 110 and existing network infrastructure 201. The wireless backhaul connections 214 may be provided using one or more wireless technologies, such as GSM, GPRS, EV-DO, UMTS, HSDPA, WiFi, WiMAX, microwave, satellite, and the like, as well as various combinations thereof.

The mesh networking capabilities provided by 911-NOW nodes 110, in combination with backhaul networking capabilities provided by 911-NOW nodes 110 using wireless backhaul connections with the existing network infrastructure 201, enable communications between emergency personnel at one emergency site (e.g., between users connected to 911-NOW nodes 110 of a standalone 911-NOW mesh network), between emergency personnel at different emergency sites (e.g., between users connected to 911-NOW nodes 110 of different standalone wireless mesh networks), between emergency personnel at one or more emergency sites and emergency management personnel (e.g., users stationed at emergency headquarters 220), and the like, as well as various combinations thereof.

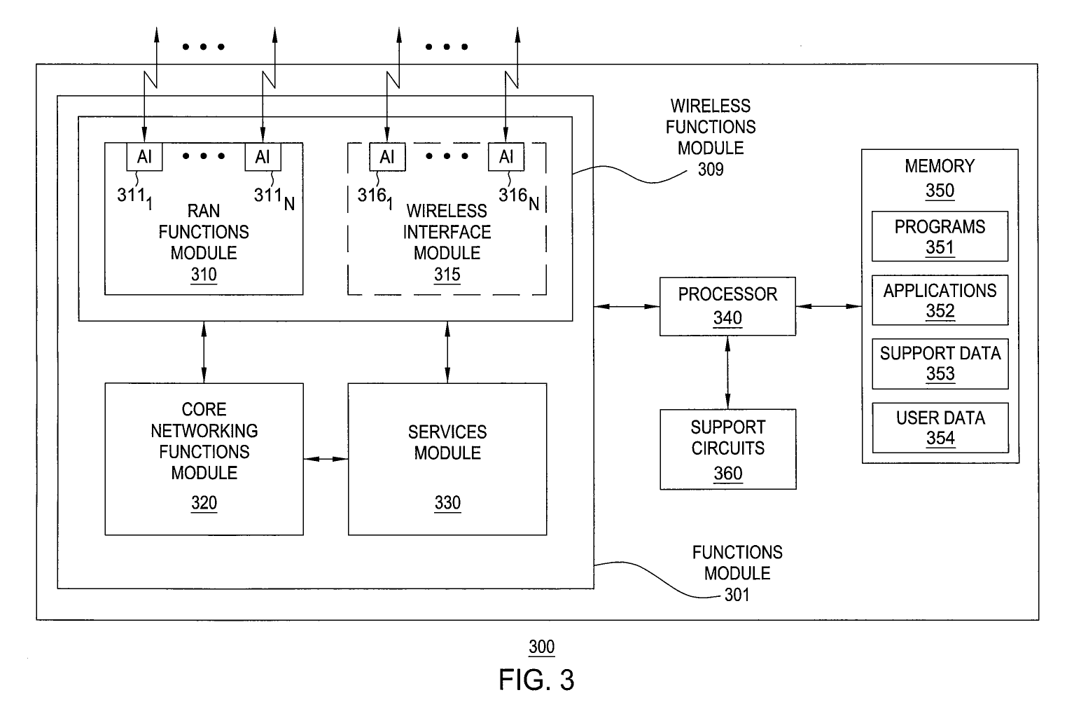

Thus, 911-NOW nodes 110 may each support four different types of wireless interfaces. The 911-NOW nodes 110 support one or more wireless access interfaces by which user devices 104 may access 911-NOW nodes 110. The 911-NOW nodes 110 support one or more wireless mesh interfaces by which 911-NOW nodes 110 communicate with other 911-NOW nodes 110. The 911-NOW nodes 110 support one or more wireless backhaul interfaces by which the 911-NOW nodes 110 communicate with existing network infrastructure. The 911-NOW nodes 110 support one or more wireless management interfaces by which network administrators may manage the 911-NOW-based wireless network. The functions of a 911-NOW node 110 may be better understood with respect to FIG. 3.

FIG. 3 depicts a high-level block diagram of one embodiment of a 911-NOW node. Specifically, as depicted in FIG. 3, 911-NOW node 110 includes a functions module 301, a processor 340, a memory 350, and support circuit(s) 360 (as well as various other processors, modules, storage devices, support circuits, and the like required to support various functions of 911-NOW node 110). The functions module 301 cooperates with processor 340, memory 350, and support circuits 360 to provide various functions of 911-NOW node 110, as depicted and described herein).

The processor 340 controls the operation of 911-NOW node 110, including communications between functions module 301, memory 350, and support circuit(s) 360. The memory 350 includes programs 351, applications 352, support data 353 (e.g., user profiles, quality-of-service profiles, and the like, as well as various combinations thereof), and user data 354 (e.g., any information intended for communication to/from user devices associated with 911-NOW node 110). The memory 350 may store other types of information. The support circuit(s) 360 may include any circuits or modules adapted for supporting functions of 911-NOW node 110, such as power supplies, power amplifiers, transceivers, encoders, decoders, and the like, as well as various combinations thereof.

The functions module 301 includes a wireless functions module 309, a core (CORE) networking functions module 320, and a services module 330. The wireless functions module 309 includes a radio access network (RAN) functions module 310 and, optionally, a wireless interface module 315. The CORE networking functions module 320 provides CORE networking functions. The services module 330 provides one or more services. The RAN functions module 310 (and, when present, wireless interface module 315) communicate with both CORE networking functions module 320 and services module 330, and CORE networking functions module 320 and services module 330 communicate, to provide functions depicted and described herein.

The wireless functions module 309, CORE networking functions module 320, and services module 330 cooperate (in combination with processor 340, memory 350, and support circuits 360, and any other required modules, controllers, and the like, which are omitted for purposes of clarity) to provide a rapidly deployable wireless node which may form: (1) a single-node, standalone wireless network; (2) a multi-node, standalone wireless network (i.e., using wireless mesh connections between 911-NOW nodes); or (3) an integrated wireless network (i.e., using wireless backhaul connections between one or more 911-NOW nodes and existing network infrastructure and, optionally, using wireless mesh connections between 911-NOW nodes).

The RAN functions module 310 provides RAN functions. The RAN functions include supporting one or more wireless access interfaces for communications associated with wireless user devices. Specifically, RAN functions module 310 supports a plurality of air interfaces (AIs) 311₁-311_{N} (collectively, AIs 311). The AIs 311 provide wireless access interfaces supporting communications associated with wireless user devices. For example, AIs 311 may support functions typically provided by a base transceiver station (BTS).

The RAN functions module 310 provides control functions. The control functions may include any control functions typically performed by controllers in radio access networks. For example, the control functions may include functions such as admission control, power control, packet scheduling, load control, handover control, security functions, and the like, as well as various combinations thereof. For example, in one embodiment, the control functions may include functions typically performed by RAN network controllers (RNCs) or similar wireless network controllers.

The RAN functions module 310 provides network gateway functions. The network gateway functions may include any functions typically performed in order to bridge RAN and CORE networks, such as IP session management functions, mobility management functions, packet routing functions, and the like, as well as various combinations thereof. For example, where intended for use with CDMA2000-based wireless technology, the network gateway functions may include functions typically performed by a Packet Data Serving Node (PDSN). For example, where intended for use with GPRS-based and/or UMTS-based wireless technology, the network gateway functions may include functions typically performed by a combination of a GPRS Gateway Support Node (GGSN) and a Serving GPRS Support Node (SGSN).

In one embodiment, RAN functions module 310 may be implemented as a base station router (BSR). In one such embodiment, the BSR includes a base station (BS) or one or more modules providing BS functions, a radio network controller (RNC) or one or more modules providing RNC functions, and a network gateway (NG) or one or more modules providing NG functions. In such embodiments, RAN functions module 310 supports any functions typically supported by a base station router.

The wireless interface module 315 provides one or more wireless interfaces. The wireless interfaces provided by wireless interface module may include one or more of: (1) one or more wireless mesh interfaces supporting communications with other 911-NOW nodes; (2) one or more wireless backhaul interfaces supporting communications with existing network infrastructure; and/or (3) one or more wireless management interfaces supporting communications with one or more management devices. The wireless interface module 315 supports a plurality of air interfaces (AIs) 316₁-316_{N} (collectively, AIs 316), which provide wireless interfaces supporting communications associated with one or more of: one or more other 911-NOW nodes, existing network infrastructure, and one or more management devices.

In one embodiment, a 911-NOW node 110 is implemented without wireless interface module 315 (e.g., if the 911-NOW node 110 is not expected to require wireless mesh, backhaul, or management capabilities). In one embodiment, a 911-NOW node 110 includes a wireless interface module 315 supporting a subset of: one or more wireless mesh interfaces, one or more wireless backhaul interfaces, and one or more wireless management interfaces (i.e., the 911-NOW node is tailored depending on whether the 911-NOW node 110 will require wireless management, mesh, and/or backhaul capabilities). In one embodiment, a 911-NOW node 110 includes a wireless interface module 315 supporting each of: one or more wireless mesh interfaces, one or more wireless backhaul interfaces, and one or more wireless management interfaces (i.e., all types of wireless interfaces are available should the 911-NOW node 110 require such wireless capabilities).

The CORE networking functions module 320 provides networking functions typically available from the CORE network. For example, CORE networking functions module 320 may provide authentication, authorization, and accounting (AAA) functions, domain name system (DNS) functions, dynamic host configuration protocol (DHCP) functions, call/session control functions, and the like, as well as various combinations thereof. One skilled in the art knows which functions are typically available from the CORE network.

The services module 330 provides services. The services may include any services capable of being provided to wireless user devices. In one embodiment, for example, services module 330 may provide services typically provided by application servers, media servers, and the like, as well as various combinations thereof. For example, services may include one or more of voice services, voice conferencing services, data transfer services (e.g., high-speed data downloads/uploads, file transfers, sensor data transfers, and the like), video services, video conferencing services, multimedia services, multimedia conferencing services, push-to-talk services, instant messaging services, and the like, as well as various combinations thereof. One skilled in the art knows which services are typically available over RAN and CORE networks.

Although primarily depicted and described herein with respect to a specific configuration of a 911-NOW node including three modules providing wireless functions (including RAN functions and, optionally, additional wireless interfaces and associated interface functions), CORE networking functions, and services, respectively, 911-NOW nodes may be implemented using other configurations for providing wireless functions, CORE networking functions, and services. Similarly, although primarily depicted and described herein with respect to a specific configuration of a functions module providing specific wireless functions, CORE networking functions, and services, functions modules of 911-NOW nodes may be implemented using other configurations for providing wireless functions, CORE networking functions, and services.

Therefore, it is contemplated that at least a portion of the described functions may be distributed across the various functional modules in a different manner, may be provided using fewer functional modules, or may be provided using more functional modules. Furthermore, although primarily depicted and described with respect to specific wireless functions (including RAN functions and, optionally, one or more additional wireless interface functions), CORE networking functions, and services, it is contemplated that fewer or more wireless functions (including RAN functions, optionally, and one or more additional wireless interface functions), CORE networking functions, and/or services may be supported by a 911-NOW node. Thus, 911-NOW nodes are not intended to be limited by the example functional architectures depicted and described herein with respect to FIG. 3.

The present invention enables dynamic control of pilot signals that emanate from base stations in a wireless network. More specifically, the present invention enables dynamic control of the power of pilot signals that emanate from base stations in a wireless network. The present invention controls base station pilot signal transmit power (referred to more generally herein as base station transmit power) of base stations in a wireless network in order to optimize the performance of the network, which may be evaluated using network performance metrics, such as: (1) coverage (e.g., defined in terms of an average number of dropped calls and/or ineffective new call attempts due to insufficient signal strength); (2) average system capacity; (3) maximum equal rate throughput (e.g., per base station); (4) minimum edge user rate guarantees; (5) maximum number of equal throughput users supported by the network; and the like, as well as various combinations thereof.

In general, when a service is made available to multiple mobile users in a cellular network being served by multiple base stations, the quality of the service depends on the minimum data rate that any user in the network can support. Therefore, in order to optimize network performance for the service (and, thus, the quality of the service), a minimum per-user data rate supported by the network should be maximized. As described herein, the minimum per-user rate of the network can be maximized by changing the user partition in the network (i.e., by changing which wireless user devices are associated with each base station). As further described herein, the user partition of a wireless network can be modified by adjusting (e.g., increasing or decreasing) the transmit power of one or more base stations of the wireless network. The per-user rate metrics and base station transmit power adjustments are described in detail herein.

In order to dynamically adjust a base station transmit power of a base station, a base station transmit power adjustment value is determined for the base station, which may be a predetermined amount by which a base station should adjust its transmit power, or a computed amount by which a base station should adjust its transmit power. In one embodiment, a base station transmit power adjustment value for a base station may be determined by that base station, locally (e.g., using a distributed approach in which each base station is responsible for determining its own base station transmit power adjustment values). In one embodiment, a base station transmit power adjustment value for a base station may be determined by a central controller (e.g., a base station in the network that is configured to operate as a central controller, a management system, and the like) and distributed to the base station.

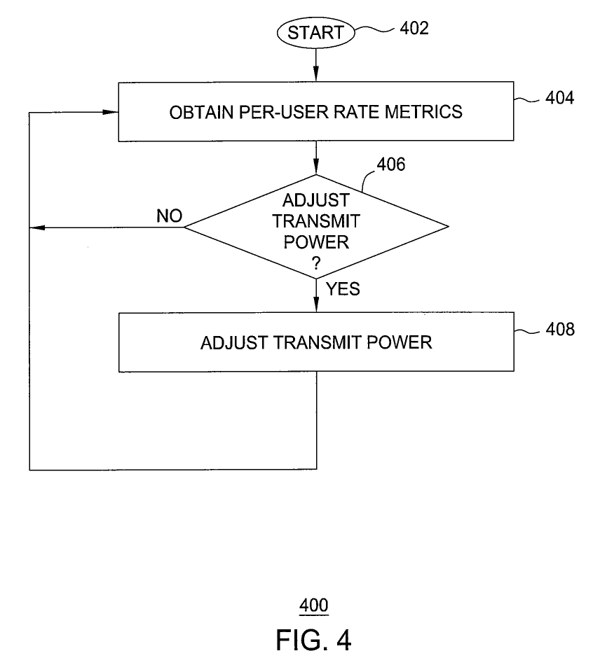

A base station transmit power adjustment may be determined in a number of different ways. In one embodiment, a base station transmit power adjustment is determined for a base station by evaluating rate metrics (i.e., by evaluating a rate metric associated with that base station and rate metrics associated with one or more other base stations). In one such embodiment, the rate metrics evaluated for the base stations are per-user rate metrics. In one such embodiment, the per-user rate metric for a base station b (denoted herein by C_{b}/N_{b}) may be determined as a ratio of a metric associated with base station b (denoted herein as C_{b}) to a number of users currently supported by the base station b (which is denoted herein as N_{b}). The metric may be any metric which may be used to determine a per-user rate metric according to the present invention, such as an average system throughput of base station b, an aggregate cell capacity for base station b, and the like, as well as various combinations thereof. A method according to one embodiment of the present invention (e.g., using per-user rate metrics to perform base station transmit power adjustments) is depicted and described with respect to FIG. 4.

FIG. 4 depicts a method according to one embodiment of the present invention. Specifically, method 400 of FIG. 4 includes a method for obtaining and evaluating per-user rate metrics for use in adjusting a transmit power of a base station. Although depicted and described with respect to one base station, method 400 of FIG. 4 may be periodically performed for each base station in the network. Although primarily depicted and described as being performed serially, at least a portion of the steps of method 400 of FIG. 4 may be performed contemporaneously, or in a different order than depicted and described with respect to FIG. 4. The method 400 begins at step 402 and proceeds to step 404.

At step 404, metric information is obtained. The metric information includes information adapted for use in determining whether to adjust a transmit power of a base station (and, optionally, if the transmit power is to be adjusted, for dynamically computing the amount by which the transmit power is to be adjusted or a value to which the transmit power is to be adjusted). The metric information includes per-user rate metrics (1) for the base station for which transmit power is being adjusted and (2) for one or more other base stations. As described herein, the per-user rate metric C_{b}/N_{b} for base station b may be determined as a ratio of a metric C_{b} associated with base station b to a number of users N_{b} currently supported by the base station b. The metric may be any metric which may be used to determine a per-user rate metric according to the present invention, such as an average system throughput of base station b, an aggregate cell capacity for base station b, and the like, as well as various combinations thereof.

In one embodiment, a per-user rate metric for a base station may be obtained using feedback information, such as one or more of data rate request feedback information, channel state feedback information, pilot signal strength measurement feedback information, and the like, as well as various combinations thereof. The data rate request feedback information may be received as data rate control (DRC) messages or other messages providing similar information. The pilot signal strength measurement feedback information may be received as pilot signal strength measurement metric (PSMM) messages, per call measurement data (PCMD) message, or other messages providing similar information. A PSMM message received from a wireless user device includes a measure of the pilot signal strength for each pilot signal received by the wireless user device (from the base station serving the wireless user device, as well as peripheral base stations not currently serving the wireless user device).

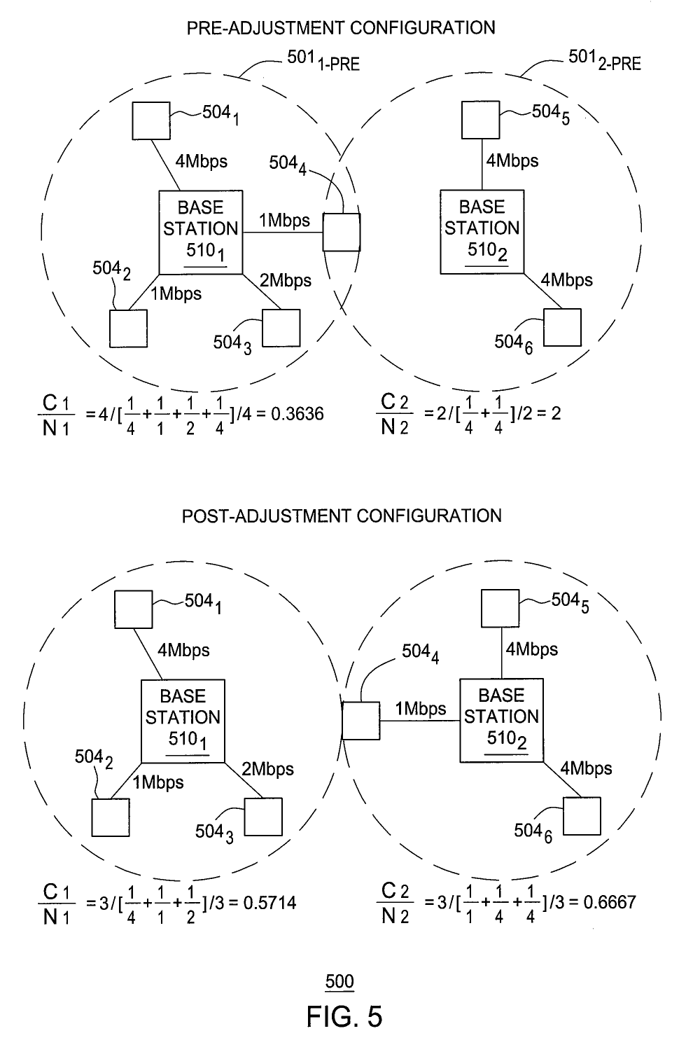

In one embodiment, PSMM messages, or similar messages including pilot signal strength measurement metric information, may be used, in conjunction with the per-user rate metrics, to provide computation of base station transmit power adjustment values. In this embodiment, the PSMM information may be considered to be part of the metric information that is obtained for use in determining whether to adjust the base station transmit power. As described herein, PSMM information may be used to provide a more dynamic form of base station transmit power control than is otherwise available in the absence of PSMM information where base station transmit power adjustments are static (i.e., where base station transmit power adjustments are made using preconfigured values). The differences between embodiments in which PSMM information is not used and in which PSMM information is used may be better understood with respect to FIG. 5.

As described herein, where per-user rate metrics are used in order to perform base station transmit power adjustments, per-user rate metrics must be obtained (1) for the base station for which transmit power is being adjusted and (2) for one or more other base stations. The manner in which the per-user rate metric C_{b}/N_{b} for a base station b is determined may depend on the base station metric C_{b} upon which the per-user rate metric C_{b}/N_{b} for base station b is based (e.g., average system throughput of base station b, aggregate cell capacity of base station b, and the like). For purposes of clarity in describing the present invention, the invention is primarily depicted and described within the context of an embodiment in which the base station metric C_{b} upon which the per-user rate metric C_{b}/N_{b} for base station b is based is the average system throughput of base station b.

In one embodiment, the per-user rate metric C_{b}/N_{b} for a base station b may be determined by: (1) computing, estimating, or otherwise determining the average system throughput C_{b} of base station b, (2) computing, estimating, or otherwise determining the number of users N_{b} currently supported by base station b, and (3) dividing the average system throughput C_{b} of base station b by the number of users N_{b} currently supported by base station b. The number of users N_{b} currently supported by the base station b may be determined in any manner (e.g., using feedback information from the wireless user devices). The average system throughput C_{b} of base station b may be determined (e.g., computed or estimated) in a number of different ways.

In one embodiment, the average system throughput C_{b} of base station b may be configured to be a constant. This embodiment may be useful in implementations in which feedback information from the wireless user devices is unavailable, or in which network capacity is limited such that exchanging various types of mobile feedback information will consume valuable network resources. In another embodiment, the average system throughput C_{b} of base station b may be computed or estimated using feedback information from the wireless user devices served by base station b (e.g., data rate request information, channel state information, PSMM information, and the like, as well as various combinations thereof). The average system throughput C_{b} of base station b may be computed, estimated, or otherwise determined in various other ways.

In one embodiment, average system throughput C_{b} of base station b is dependent on date rate requests (denoted herein as data rate requests R) to base station b from wireless user devices served by base station b. Thus, in one embodiment, average system throughput C_{b} of base station b may be computed as C_{b}=N_{b}/[Σ(1/R_{ub})], where R_{ub} is the date rate request (DRC) from wireless user device u to base station b, and N_{b} is the number of wireless user devices currently supported by base station b. The per-user rate metric C_{b}/N_{b} of base station b may thus be computed as C_{b}/N_{b}=α/[Σ(1/R_{ub})], where α is configurable. Therefore, in such embodiments, per-user rate metric C_{b}/N_{b} may be computed or estimated directly from feedback information without requiring an intermediate step of computing or estimating average system throughput C_{b}.

In one embodiment, per-user rate metric C_{b}/N_{b} of base station b may be computed using actual data rate request values R received from wireless user devices served by base station b. In one embodiment, per-user rate metric C_{b}/N_{b} of base station b may be computed using estimated data rate request values R, which may be estimated using other feedback information received from wireless user devices served by base station b (e.g., using CSI information, PSMM information, and the like, as well as various combinations thereof).

The data rate request values R for wireless user devices served by a base station may be obtained in a number of different ways. In one embodiment, actual data rate request values R for wireless user devices served by a base station may be obtained directly, i.e., as feedback from the wireless user devices. In one embodiment, estimated data rate request values R for wireless user devices served by a base station may be obtained using other types of feedback from the wireless user devices (e.g., using one or more of CSI information, PSMM information, and the like, as well as various combinations thereof).

In one embodiment, in which PSMM information is received from wireless user devices served by base station b, the PSMM information may be processed to estimate the data rate request values R for wireless user devices served by base station b. In another embodiment, in which PSMM information is received from wireless user devices served by base station b, the PSMM information may be processed to determine CSI information for base station b, and then the CSI information determined from the PSMM information may be used to estimate data rate request values R for wireless user devices served by base station b.

In one embodiment, in which CSI information is received from wireless user devices served by base station b, the received CSI information may be processed in order to estimate data rate request values R for wireless user devices served by base station b. Similarly, in one embodiment, in which CSI information is estimated using PSMM information (and/or using other feedback information received from wireless user devices served by base station b), the estimated CSI information may be processed in order to estimate data rate request values R for wireless user devices served by base station b.

Furthermore, although primarily depicted and described herein with respect to embodiments in which the per-user rate metric C_{b}/N_{b} of base station b is specifically computed or estimated using actual data rate request values, or using data rate request values R estimated using other types of feedback information (e.g., CSI, PSMM, and the like), in some embodiments, per-user rate metric C_{b}/N_{b} of base station b may be estimated directly without explicitly computing or even estimating data rate request values R for base station b). For example, per-user rate metric C_{b}/N_{b} of base station b may be estimated directly by evaluating feedback information such as CSI information, PSMM information, and the like, as well as combinations thereof.

As described herein, per-user rate metrics may be obtained in various different ways, e.g., using various combinations of information which may be obtained and distributed in various different ways. For example, a per-user rate metric for a base station may be obtained by determining a metric for a base station (e.g., average system throughput, aggregate cell capacity, and the like) and dividing the base station metric by the number of users served by the base station, by estimating the per-user rate metric directly without using an intermediate step of determining the base station metric (e.g., where the per-user rate metric may be determined from data rate request information if the base station metric used to determine the per-user rate metric is the average system throughput of the base station), and the like, as well as various combinations thereof. Thus, the various functions of the present invention may be implemented using a distributed architecture, using a centralized architecture, or using a combination centralized-distributed architecture.

In one embodiment, a distributed architecture may be used to obtain per-user metrics for performing base station transmit power adjustments.

In one embodiment of a distributed architecture, each base station in the network may obtain its own per-user rate metric (e.g., computing or estimating its per-user rate metric), and distribute its per-user rate metric to other base stations in the network (which may include all base stations in the network, or a selected subset of base stations in the network). In this manner, each base station obtains its own per-user rate metric, as well as per-user rate metric(s) of at least some of the other base stations in the network, and can evaluate the per-user rates in order to adjust its own base station transmit power.

In one embodiment of a distributed architecture, each base station in the network may distribute information (e.g., feedback information and/or computed/estimated information) to other base stations in the network (which may include all base stations of the network, or a selected subset of the base stations of the network) which the other base stations may process in order to determine the per-user rate metric for that base station. In this manner, each base station may determine its own per-user rate using its own feedback information received from wireless user devices it is serving and, further, may determine per-user rate metrics of one or more neighboring base stations by processing information received from the neighboring base stations (to compute or estimate a per-user rate metric for each of the neighboring base stations) and, thus, can evaluate the per-user rates in order to adjust its own base station transmit power.

As one example, a base station may determine its own base station metric C_{b} (e.g., average system throughput, aggregate cell capacity, and the like) and the number of wireless user devices N_{b} that it currently supports, and provide this information to one or more other base stations. As another example, a base station may receive data rate request feedback information, compute its per-user rate metric from the data rate request information, and provide its per-user rate metric to one or more other base stations. As another example, a base station may receive CSI information and/or PSMM information from wireless user devices it is currently serving, estimate data rate request values R from this information, and provide the estimated data rate request values R to one or more other base stations. As another example, a base station may receive CSI information and PSMM information from wireless user devices it is currently serving, and distribute this feedback information to one or more other base stations. Thus, various combinations of information may be distributed by each of the base stations of the network to other base stations of the network (for use by other base stations to compute such values as data rate request values, per-user rate metrics, and the like, as well as various combinations thereof).

In one embodiment, a centralized architecture may be used to obtain per-user rate metrics for performing base station transmit power adjustments. As described hereinbelow, the centralized architecture may be implemented either as a purely centralized architecture (e.g., where all transactions are between a base station and a central controller) or as a partially centralized architecture in which some functions are also distributed across the base stations (e.g., where each base station exchanges information both with a central controller, as well as with other base stations in the network, in order to obtain per-user rate metrics which may be evaluated to adjust base station transmit power).

In one embodiment of a centralized architecture, feedback information received from wireless user devices being served by a base station may be forwarded by that base station to the central controller. The central controller may process the feedback information in different ways, such as: (1) to compute or estimate CSI information from PSMM information, (2) to compute or estimate data rate request values R from one or more of CSI information, PSMM information, and the like; (3) to compute or estimate the per-user rate metric C_{b}/N_{b} for base station b from computed or estimated data rate request values, or to compute or estimate the per-user rate metric C_{b}/N_{b} for base station b directly from one or more of CSI information, PSMM information, and the like; (4) to compute or estimate average system throughput C_{b} of a base station b (or another base station metric of base station b); (5) and the like, as well as various combinations thereof.

In some embodiments, the central controller may distribute some or all of the information computed or estimated for a base station (i.e., based on feedback information received from the base station) to the base station from which the feedback information was obtained. In such embodiments, upon receiving information from the central controller, the base station may then operate using any of the distributed approaches described herein, depending on the information received from the central controller. In one embodiment, the base station may distribute the received information to one or more other base stations. In one embodiment, the base station may use the received information to compute or estimate one or more other values which may then be distributed to one or more other base stations.

As one example, where the base station receives its average system throughput C_{b} from the central controller (or another base station metric for the base station), the base station may compute or estimate its own per-user rate metric and distribute its per-user rate metric to one or more other base stations, the base station may distribute its C_{b} and N_{b} information to one or more other base stations which may use the received C_{b} and N_{b} information to compute the per-user rate metric for that base station, and the like. As another example, where the base station receives estimated data rate request values R from the central controller, the base station may compute or estimate its per-user rate metric from the data rate request values R, the base station may distribute the estimated data rate request values R to one or more other base stations, and the like. Thus, different combinations of information may be distributed by each of the base stations of the network.

In other embodiments, the central controller may distribute some or all of the information computed or estimated for a base station (i.e., based on feedback information received from the base station, or even information that is computed by the base station and provided to the central controller) to one or more of the other base stations of the network. In one embodiment, the central controller may distribute some or all of the information to each of the base stations of the network. In one embodiment, the central controller may distribute some or all of the information to selected subsets of the base stations in the network (e.g., to base stations which the central controller has identified as being neighbors of that base station for which the information was computed or estimated).

As one example, the central controller may compute the per-user rate metric C_{b}/N_{b} for a base station and distribute the per-user rate metric C_{b}/N_{b} for the base station to one or more other base stations. As another example, the central controller may determine the base station metric C_{b} of the base station (e.g., average system throughput, aggregate cell capacity, and the like) and distribute the average system throughput to one or more other base stations. As another example, in continuation of the previous example, where the central controller also determines the number of users N_{b} being served by the base station, the central controller may compute the per-user rate metric C_{b}/N_{b} for the base station and distribute the per-user rate metric C_{b}/N_{b} to one or more other base stations. Thus, different combinations of information may be distributed, by the central controller, to various different combinations of base stations.

In one embodiment, a central controller may distribute some or all of the feedback information received from a base station to one or more other base stations of the network. In one embodiment, the central controller may only distribute feedback information to other base stations (e.g., if the central controller does not include any feedback information processing capabilities but, rather, functions as a controller for purposes of facilitating exchange of feedback information between base stations). In one embodiment, the central controller may distribute some or all of the feedback information received from the base station, in addition to distributing information computed or estimated using feedback information received from the base station.

As one example, the central controller may distribute data rate request values received from a base station to one or more other base stations (for use by the other base stations in computing per-user rate metrics). As another example, the central controller may distribute PSMM information received from the base station to one or more other base stations (e.g., for use by the other base stations in estimating data rate request values R which may be used to estimate per-user rate metrics, for use in providing more advanced control of base station transmit power, and the like). As another example, the central controller may distribute a per-user rate metric computed by the central controller for a base station, as well as PSMM information received from the base station, to one or more other base stations.

Thus, any combination of base stations and/or one or more central controllers may cooperate to obtain and process information in a manner for ensuring that each base station obtains its own per-user rate metric and at least one other per-user rate metric of at least one other base station in the network such that each base station may evaluate the per-user rate metrics for determining whether or not to adjust their respective base station transmit powers. Therefore, although different embodiments have been described herein, the present invention may be implemented using any combination of any of the embodiments described herein, as well as any other means of enabling a base station to obtain its own per-user rate metric and at least one other per-user rate metric of at least one other base station in the network such that the base station may evaluate the per-user rate metrics in order to determine whether or not to adjust its base station transmit power.

At step 406, a determination is made as to whether or not the transmit power of the base station should be adjusted. The determination as to whether or not the transmit power of the base station should be adjusted is performed using the per-user rate metrics (i.e., the per-user rate metric of the base station for which the determination is being made and per-user rate metric(s) of other base station(s)). In one embodiment, the determination as to whether or not the transmit power of the base station should be adjusted may be performed using the per-user rate metrics in combination with PSMM information. If the transmit power of the base station should not be adjusted, method 400 returns to step 404, at which point additional per-user rate metrics may be obtained. If the transmit power of the base station should be adjusted, method 400 proceeds to step 408.

With respect to determining whether or not to adjust the transmit power of a base station, it should be noted that for a service providing equal data rates to all wireless user devices in the network that are using that service (e.g., a voice conferencing service, a data multicast service, a video service, and like services), the quality of the provided service is dependent on the minimum value of the equal data rates provided by respective base stations in the network. In other words, when a service is available to multiple mobile consumers in a cellular network being served by multiple base stations, the quality of service depends on the minimum data rate any user in the network can support, and, thus, if the information is provided at a higher data rate, any wireless user device that is unable to support that higher data rate will be unable to properly receive the information and, thus, quality of service in the network suffers.

Since each base station in the network is thus constrained by the one base station in the network that is providing the minimum data rate, in order to optimize network performance the minimum data rate by which the network is constrained should be maximized. In one embodiment, the objective is then to maximize the minimum per-user rate across the network. Thus, since the per-user rate of a base station depends on the average system throughput of the base station and the number of wireless user devices served by the base station, the per-user rate of a base station may be controlled by changing the number of wireless user devices served by that base station, which changes the average system throughput of the base station and, thus, the per-user rate of the base station. As described herein, the number of wireless user devices served by a base station can be controlled by adjusting the transmit power of that base station.

For example, in one embodiment where a wireless user device is capable of being served by multiple base stations, the wireless user device will opt to be served by the base station providing the strongest signal. In this example, by lowering the transmit power of the base station currently serving the wireless user device, the wireless user device (and possibly other wireless user devices) may then switch to being served by the other base station (if the signal strength of the other base station becomes stronger than the signal strength of the base station that was originally serving that wireless user device). In this manner, base station transmit power adjustments may be executed to change the assignment of wireless user devices to base stations in the network, thereby modifying per-user rates of base stations in the network in a manner for maximizing the minimum per-user rate in the network.

As described herein, the minimum per-user rate in the network may be increased by decreasing the transmit power of the base station with which the minimum per-user rate is associated (because that reduces the number N_{b} of wireless user devices served by that base station and increases the average system throughput C_{b} of the base station, thereby increasing the per-user rate C_{b}/N_{b}). Since neighboring base stations will then begin serving any of the wireless user devices no longer served by the base station which reduced transmit power, the per-user rates of the neighboring base stations will be reduced (because the number N_{b} of wireless user devices served by those neighboring base stations is increased and the average system throughput C_{b} of the neighboring base stations is decreased). Thus, changes to transmit power of one base station that are made to modify the per-user rate of the base station will affect per-user rates of neighboring base stations (and, thus, propagate such that per-user rates of base stations throughout the network are modified). An example of this effect is depicted and described herein with respect to FIG. 5.

Thus, the determination as to whether or not the transmit power of a target base station should be adjusted may be made by comparing the per-user rate metric of the target base station with the per-user rate metric(s) of one or more base stations in the vicinity of the target base station (and, as described herein, optionally using PSMM information in order to determine the effects of potential base station transmit power adjustments before those base station transmit power adjustments are implemented) In one embodiment, the base station transmit power of the base station (or base stations) having the lowest per-user rate metric may be reduced (i.e., in order to increase average system throughput C_{b} and reduce the number of wireless user devices N_{b} being served, thereby increasing the per-user rate metric for the base station). The evaluation of per-user rate metrics (and, optionally, PSMM information) in order to determine whether or not to adjust base station transmit power may be better understood with respect to FIG. 5.

At step 408, the transmit power of the base station is adjusted. The base station transmit power may be adjusted using any means of adjusting the transmit power of a base station. For example, the transmit power of a base station may be adjusted by controlling an internal power source or power booster, by controlling an external power source or power booster, and the like, as well as various combinations thereof.

In one embodiment, the transmit power of the base station is adjusted by a predetermined amount of transmit power. For example, the transmit power of the base station may be adjusted by a predetermined amount, by a predetermined percentage, and the like.

In one embodiment, the transmit power of the base station is adjusted by a computed amount of transmit power (or, equivalently, to a computed transmit power value). In this embodiment, the base station transmit power adjustment may be computed using a combination of the per-user rate metrics and the pilot signal strength measurement metric information. The base station transmit power adjustment may be computed in any manner for computing a base station transmit power value using per-user rate metrics and pilot signal strength measurement metric information.

In one embodiment, for example, the base station may select multiple possible transmit power values and compute per-user rate metrics for the base stations based on each of the possible transmit power values in order to quantify the different effects of using the different transmit powers. In this embodiment, the base station may then select one of the evaluated base station transmit power values (e.g., the base station transmit power value producing the optimal associated per-user rate metric value) as the transmit power to be used by the base station. In this embodiment, there is a tradeoff between the number of possible base station transmit power values evaluated and the accuracy of the selected base station transmit power value (e.g., evaluation of more possible values produces a better result at the expense of requiring more time and resources).

In one embodiment, for example, the base station may iteratively select possible transmit power values, and evaluate the effect of using each of the selected transmit power value, in order to approach an optimum base station transmit power value. In this embodiment, there is a tradeoff between the number of iterations performed and the accuracy of the resulting base station transmit power value (e.g., performing more iterations produces a better result at the expense of requiring more time and resources). In one embodiment, the base station attempts to approach the optimal base station transmit power value using the smallest number of iterations possible. In another embodiment, the base station attempts to approach the optimal base station transmit power value using as many iterations as may be required.

With respect to embodiments using dynamic base station transmit power adjustments, although primarily depicted and described herein with respect to computing a specific base station transmit power value, in other embodiments the computed value may be represented as an amount by which the base station transmit power should be adjusted. For example, in one embodiment, the base station may compute a base station transmit power adjustment value indicative of an amount by which the base station transmit power should be adjusted (rather than a value to which the transmit power should be set). In this embodiment, the base station transmit power adjustment value may be represented using an amount of transmit power (e.g., adjust the base station transmit power by 3 dB), a percentage of transmit power (e.g., adjust the base station transmit power by 10%), or any other similar measure.

From step 408 (similar to step 406 when the transmit power of the base station is not adjusted), method 400 returns to step 404, at which point method 400 is repeated using newly obtained per-user rate metrics. In other words, whether or not the base station transmit power of the base station is adjusted, method 400 may continue to be repeated in order to determine whether or not to adjust the transmit power of the base station. In one embodiment, step 404 may be performed immediately (such that method 400 is continuous). In another embodiment, step 404 may be performed after a delay, which may be configured such that method 400 is performed periodically and/or in response to one or more trigger conditions.

Although primarily depicted and described with respect to a per-user rate metric, since base stations may support different types of sessions (e.g., voice sessions, data sessions, video sessions, and the like, as well as various combinations thereof), in one embodiment the per-user rate metric may be adapted to a per-user/per-flow rate metric which accounts for the different types of sessions supported by the base station. In one such embodiment, the per-user/per-flow metric may be computed as a summation of the per-user rates for each type of session supported by that base station. For example, for a base station supporting voice, data, and video sessions, per-user/per-flow rate metric C_{b}/N_{b}=(C_{b}/N_{b})_{VOICE}+(C_{b}/N_{b})_{DATA}+(C_{b}/N_{b})_{VIDEO}, where each individual (C_{b}/N_{b})_{<SESSION TYPE>} is computed as described herein with respect to the per-user rate metric (but only considering sessions of the specified type).

FIG. 5 depicts a high-level block diagram of a wireless network. As depicted in FIG. 5, wireless network 500 includes a pair of base stations 510₁ and 510₂ (collectively, base stations 510) serving a plurality of wireless user devices 504₁-504₆ (collectively, wireless user devices 504). For example, base stations 510 may include base stations of respective 911-NOW nodes 110 depicted and described with respect to FIG. 1 and FIG. 2, and, similarly, wireless user devices 504 may include wireless user devices 104 depicted and described with respect to FIG. 1 and FIG. 2 (e.g., laptops, cell phones, PDAs, and the like). FIG. 5 depicts the effects of an adjustment of base station transmit power and, thus, a pre-adjustment network configuration and a post-adjustment network configuration are depicted and described.

As depicted in the pre-adjustment configuration of FIG. 5, base station 510₁ is transmitting with a transmit power resulting in base station coverage area 501_{1-PRE} and base station 510₂ is transmitting with a transmit power resulting in base station coverage area 501_{2-PRE}. The base station coverage area 501_{1-PRE} is larger than base station coverage area 501_{2-PRE}, meaning that the base station transmit power of base station 510₁ is larger than the base station transmit power of base station 510₂. The base station coverage area 501_{1-PRE} and base station coverage area 501_{2-PRE} partially overlap in the region in which wireless user device 504₄ is geographically located, such that wireless user device 504₄ is capable of being served by either base station 510₁ or base station 510₂.

As depicted in the pre-adjustment configuration of FIG. 5, wireless user devices 504₁-504₄ are being served by base station 510₁ and wireless user devices 504₅ and 504₆ are being served by base station 510₂. Since wireless user device 504₄ may be served by multiple base stations, wireless user device 504₄ will select one of the available base stations (e.g., the base station providing the strongest pilot signal), which, in the pre-adjustment configuration, is base station 510₁. The wireless user devices 504₁-504₄ being served by base station 510₁ are capable of supporting data rates of 4 Mbps, 1 Mbps, 2 Mbps, and 1 Mbps, respectively. The wireless user devices 504₅ and 504₆ being served by base station 510₂ are capable of supporting data rates of 4 Mbps and 4 Mbps, respectively.

As described herein, each wireless user device periodically provides data rate feedback information to the base station serving that wireless user device The wireless user devices 504₁-504₄ periodically report respective data rates of 4 Mbps, 1 Mbps, 2 Mbps, and 1 Mbps to base station 510₁ (e.g., using respective DRC feedback messages transmitted over respective control channels between wireless user devices 504₁-504₄ and serving base station 510₁). The wireless user devices 504₅ and 504₆ periodically report respective data rates of 4 Mbps and 4 Mbps to base station 510₂ (e.g., using respective DRC feedback messages transmitted over respective control channels between wireless user devices 504₅ and 504₆ and serving base station 510₂).

The base stations 510 compute respective per-user rate metrics (C_{b}/N_{b}) using data rate feedback information received at the respective base stations. In the pre-adjustment configuration, the base station 510₁ computes a per-user rate metric (C1/N₁) using data rate feedback values received from wireless user devices 504₁-504₄. The per-user rate metric (C₁/N₁) computed at base station 510₁ is computed as (C₁/N₁)=4/[(1/4)+(1/1)+(1/2)+(1/1)]/4=0.3636. In the pre-adjustment configuration, the base station 510₂ computes a per-user rate metric (C₂/N₂) using data rate feedback values received from wireless user devices 504₅ and 504₆. The per-user rate metric (C₂/N₂) computed at base station 510₂ is computed as (C₂/N₂)=2/[(1/4)+(1/4)]/2=2.

The base stations 510 propagate per-user rate metrics to other base stations (e.g., either locally to neighboring base stations or globally to all base stations). In the network configuration of FIG. 5, base station 510₁ propagates per-user rate metric (C₁/N₁)=0.3636 to base station 510₂ and base station 510₂ propagates per-user rate metric (C₂/N₂)=2 to base station 510₁. From the per-user rate metrics, base stations 510₁ and 510₂ each determine that base station 510₁ has the minimum per-user rate metric (0.3636, versus 2 associated with base station 510₂). Using the per-user rate metrics, each base station 510 determines whether or not to adjust its base station transmit power.

Since the objective is to maximize the minimum per-user rate metric, upon evaluating the per-user rate metrics the base station 510₁ will determine that it should decrease its transmit power in order to decrease the number of wireless user devices it serves and increase its average throughput and, thus, increase its per-user rate metric (since per-user rate depends on the number of wireless user devices being served by that base station and the average system throughput of that base station). By contrast, the base station 510₂ will determine that it should leave its transmit power unchanged (or may alternatively decide to increase its transmit power; however, the description of this is omitted for purposes of clarity). Based on this example, base station 510₁ decreases its transmit power, as depicted and described with respect to the post-adjustment configuration of FIG. 5.

As depicted in FIG. 5, base station 510₁ decreases its transmit power (from the pre-adjustment configuration to the post-adjustment configuration). As described herein, a base station may adjust its transmit power by a predetermined amount (either by a certain amount of transmit power or by a predetermined percentage of transmit power) or may adjust its transmit power to a computed transmit power. An embodiment in which a base station adjusts its transmit power by a predetermined amount or by a predetermined percentage can be implemented by base stations where the base stations exchange per-user rate metrics. An embodiment in which a base station adjusts its transmit power to a computed transmit power can be implemented by base stations where the base stations exchange per-user rate metrics and PSMM metrics.

Without PSMM metrics, a base station cannot pre-compute the specific effects of an adjustment of its transmit power (because in the absence of PSMM metrics for that base station and neighboring base stations, that base station cannot determine how the distribution of wireless user devices will change in response to specific adjustments to its transmit power). In such embodiments, in which PSMM metrics are not available, or distribution of such information is unavailable or expensive because of backhaul resources between base stations that are available to transport such information, base stations must adjust transmit powers by a predetermined amount or by a predetermined percentage (rather than adjusting transmit powers to specific computed transmit power values). Thus, in the absence of PSMM metrics, where a base station adjusts transmit power by a predetermined value, the base station will not know the actual effects of the transmit power adjustment until the next cycle in which the per-user rate metric of the base station is computed.

With PSMM metrics, a base station can pre-compute the effect of an adjustment of transmit power (because with PSMM metrics from that base station and neighboring base stations), the base station can determine how the distribution of wireless user devices will change in response to the adjustment of transmit power. In such embodiments, in which PSMM metrics are available and distribution of such information is available using backhaul resources between base stations, base stations may adjust transmit powers to specific computed transmit powers (rather than merely adjusting transmit powers by a predetermined amount). Thus, use of PSMM metrics to compute an optimum base station transmit power provides an additional layer of intelligence in dynamic base station transmit power adjustment (in addition to the advantages provided by use of the per-user rate metric).

As described herein, a PSMM message received from a wireless user device includes a measure of the pilot signal strength for each pilot signal received by the wireless user device, where the wireless user device may receive pilot signals from the base station currently serving the wireless user device, as well as peripheral base stations in geographical proximity to the wireless user device but which are not currently serving the wireless user device. For example, for purposes of clarity in describing PSMM messages, assume that base station 510₁ receives PSMM messages from wireless user devices 504₁-504₄ and base station 510₂ receives PSMM messages from wireless user devices 504₄-504₆. The base stations 510 exchange their PSMM messages (or exchange messages including the PSMM metrics included in the received PSMM messages).

At base station 510₁, a PSMM message from wireless user device 504₁ may indicate that a pilot signal received from base station 510₁ has a strength of 1.0, a PSMM message from wireless user device 504₂ may indicate that a pilot signal received from base station 510₁ has a strength of 0.2, a PSMM message from wireless user device 504₃ may indicate that pilot signals received from base stations 510₁ and 510₂ have respective strengths of 0.5 and 0.05, and a PSMM message from wireless user device 504₄ may indicate that pilot signals received from base stations 510₁ and 510₂ have respective strengths of 0.2 and 0.2. At base station 510₂, a PSMM message from wireless user device 504₅ may indicate that a pilot signal received from base station 510₂ has a strength of 1.0, and a PSMM message from wireless user device 504₆ may indicate that a pilot signal received from base station 510₂ has a strength of 1.0.

As described herein, while base station 510₁ may determine from per-user rate metrics that it should increase or decrease its transmit power, without PSMM metrics base station 510₁ has no way of computing a specific transmit power with which it should be transmitting. By contrast, with PSMM information, base station 510₁ can compute a specific transmit power to which it should adjust. For example, since base station 510₁ knows from the per-user rate metrics (both its own and the per-user rate metric received from base station 510₂) that it should decrease its transmit power, using the PSMM message received locally, as well as the PSMM information received from base station 510₂, base station 510₁ can compute a specific transmit power to which it should adjust.

Using the PSMM metric information, base station 510₁ knows that it is serving four wireless user devices while neighboring base station 510₂ is only serving two wireless user devices. From this information, base station 510₁ may determine that it should attempt to force one of the four wireless user devices to switch to being served by base station 510₂. From the PSMM information, base station 510₁ can determine that the best candidate wireless user device for such a switch is wireless user device 504₄ because this wireless user device is receiving pilot signals from both base stations 510 and the strengths of the received pilot signals are equal (0.20 versus 0.2). From these PSMM values, base station 510₁ may then compute that it can force a handoff of wireless user device 504₄ from base station 510₁ to base station 510₂ by reducing its transmit power by 5%.

Thus, use of PSMM metrics by base stations enables base stations to compute optimum transmit power values. Although described with respect to a specific process by which a base station might evaluate PSMM metrics, base stations may evaluate PSMM metrics in various other ways in order to compute transmit power values (or, equivalently, transmit power adjustment values). In one embodiment, for example, the base station may successively select possible transmit power values and compute per-user rate metrics for the base stations in order to quantify the effects of using that transmit power. In this embodiment, the base station may then evaluate the different sets of per-user rate metrics (one set for each transmit power value simulated by the base station) in order to select the transmit power value which will provide the best resulting set of per-user rate metrics (e.g., the set having the maximum value of the minimum per-user rate metric).

With respect to the network of FIG. 5, for purposes of clarity in describing the effects of transmit power adjustments assume that base station 510₁ decreases its transmit power by a predetermined percentage (i.e., assume that PSMM metrics are not exchanged between base stations and, thus, are not used to compute a specific transmit power for base station 510₁). In continuation of the description of FIG. 5, assume that base station 510₁ is preconfigured to decrease its transmit power by 10% in response to a determination that its transmit power should be decreased. As depicted in the post-adjustment configuration of FIG. 5, base station 510₁ is transmitting with a transmit power that is 10% less than the transmit power with which base station 510₁ is transmitting in the pre-adjustment configuration of FIG. 5, and base station 510₂ is transmitting with the same transmit power with which base station 510₂ is transmitting in the pre-adjustment configuration of FIG. 5.

As depicted in the post-adjustment configuration of FIG. 5, base station 510₁ is transmitting with a transmit power resulting in base station coverage area 501_{1-POST} and base station 510₂ is transmitting with a transmit power resulting in base station coverage area 501_{2-POST}. The base station coverage area 501_{1-POST} is smaller than the base station coverage area 501_{1-PRE}, and comparable to the base station coverage area 501_{2-POST}, meaning that, in the post-adjustment configuration, the reduced base station transmit power of base station 510₁ is similar to the base station transmit power of base station 510₂. The base station coverage area 501₁ and base station coverage area 501₂ no longer overlap in the region in which wireless user device 504₄ is geographically located, however, wireless user device 504₄ receives pilot signals from both base stations 510 and, thus, may select to associate with either of the base stations 510.

As seen in the post-adjustment configuration of FIG. 5, the reduction in transmit power of base station 510₁ causes wireless user device 504₄ to switch from associating with base station 510₁ to associating with base station 510₂. For example, whereas before wireless user device 504₄ received the stronger signal from base station 510₁, following the decrease in transmit power by base station 510₁ the wireless user device 504₄ now receives a stronger signal from base station 510₂ and, thus, selects to change from associating with base station 510₁ to associating with base station 510₂. In other words, reduction of the transmit power of base station 510₁ has forced a modification of the distribution of wireless user devices in the network (i.e., changing which wireless user devices are served by which base stations).

As depicted in the post-adjustment configuration of FIG. 5, wireless user devices 504₁-504₃ are being served by base station 510₁ and wireless user devices 504₄-504₆ are being served by base station 510₂. In the post-adjustment configuration wireless user devices 504₁-504₃ being served by base station 510₁ are capable of supporting data rates of 4 Mbps, 1 Mbps, and 2 Mbps, respectively, and the wireless user devices 504₄-504₆ being served by base station 510₂ are capable of supporting data rates of 1 Mbps, 4 Mbps, and 4 Mbps, respectively. Since the per-user rate metric for a base station is dependent on the number of wireless user devices served by the base station, which affects the average system throughput of the base station, the forced modification of the distribution of wireless user devices in the network modifies respective per-user rates of base stations in the network (in a manner for maximizing the minimum per-user rate in the network).

The base stations 510 compute respective per-user rate metrics (C_{b}/N_{b}) using data rate feedback information received at the respective base stations. In the post-adjustment configuration, the base station 510₁ computes a per-user rate metric (C₁/N₁) using data rate feedback values received from wireless user devices 504₁-504₃. The per-user rate metric (C₁/N₁) computed at base station 510₁ is computed as (C₁/N₁)=3/[(1/4)+(1/1)+(1/2)]/3=0.5714. In the post-adjustment configuration, base station 510₂ computes a per-user rate metric (C₂/N₂) using data rate feedback values received from wireless user devices 504₄-504₆. The per-user rate metric (C₂/N₂) computed at base station 510₂ is computed as (C₂/N₂)=3/[(1/1)+(1/4)+(1/4)]/3=0.6667.

By reducing its base station transmit power, base station 510₁ has modified the distribution of wireless user devices in the network and, thus, has increased the minimum per-user rate metric. Namely, in the pre-adjustment configuration the minimum per-user rate metric is 0.3636, and in the post-adjustment configuration the minimum per-user rate metric is 0.5714. Since transmissions by base stations to the wireless user devices are constrained by the minimum per-user rate of all of the base stations from which the information is transmitted, quality-of-service in the network is increased by increasing the minimum per-user rate metric. Thus, quality of service in the network is improved for all wireless user devices by dynamically modifying base station transmit power.

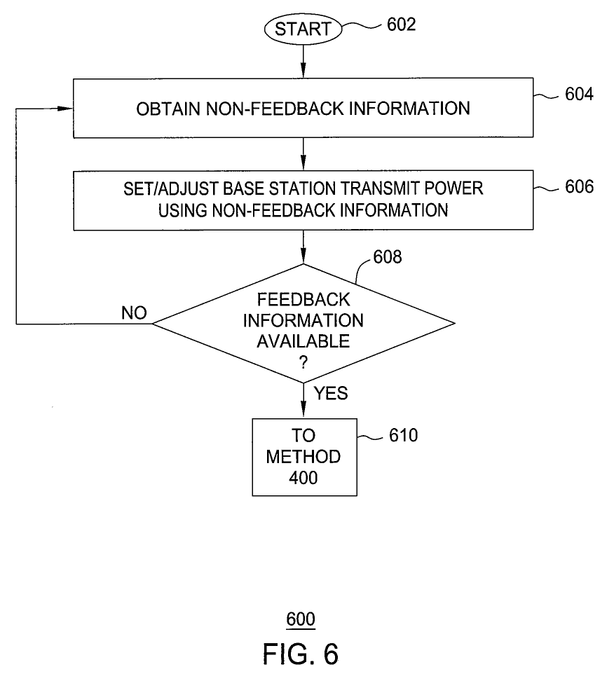

Although primarily depicted and described with respect to performing base station transmit power adjustments where the base station is operating in the network and feedback information is available from the wireless user devices, in some situations, base station transmit power adjustments may need to be performed when feedback information is not available from the wireless user device (or is not yet available from the wireless user devices). In such situations, information other than feedback information may be used to adjust the transmit power of a base station. A method according to one embodiment is depicted and described with respect to FIG. 6.

Furthermore, although primarily depicted and described herein with respect to adjusting the base station transmit power of a base station already powered on, configured, and functioning in the network, in many situations there may be a need to initially configure the base station transmit power of a base station. For example, in situations in which a network must be rapidly established (e.g., where a base station is mounted on an emergency vehicle dispatched to the scene of an emergency, as depicted and described herein with respect to FIG. 1), the base station may be expected to support wireless communications immediately upon arriving at the scene of the emergency. In one embodiment, in which feedback information is unavailable, non-feedback information may be used to initially configure the base station transmit power. A method according to one embodiment is depicted and described with respect to FIG. 6.

FIG. 6 depicts a method according to one embodiment of the present invention. Specifically, method 600 of FIG. 6 includes a method for initially configuring (and, optionally, subsequently adjusting) the transmit power of a base station using non-feedback information (i.e., using information other than feedback information described with respect to FIG. 4 and FIG. 5). Although primarily depicted and described as being performed serially, at least a portion of the steps of method 600 of FIG. 6 may be performed contemporaneously, or in a different order than depicted and described with respect to FIG. 6. The method 600 begins at step 602 and proceeds to step 604.

At step 604, information is obtained. The information is non-feedback information, which may include any information which may be used to initially configure or adjust the transmit power of a base station. The information may be obtained in any manner, which may depend on the type of information obtained. For example, the information may be obtained by the base stations and/or by a central controller (e.g., from the base stations). The information may be processed in any manner, which may depend on the type of information obtained. For example, the information may be processed by the base stations and/or by a central controller.

The information may include geographic distance information indicative of the geographic distances between base stations (or at least the geographic locations of the base stations, or associated GPS information, from which geographic distance information may be determined). For example, for a target base station for which the base station transmit power is being initially configured or adjusted, the geographic distance information that is obtained for use in setting or adjusting the transmit power of the target base station may include geographic distances between the target base station and one or more other neighboring base stations.

The information may include base station signal strength information indicative of the strength, at a target base station, of signals received from one or more neighboring base stations. For example, a target base station for which the base station transmit power is being initially configured or adjusted may measure the strength of signals received from one or more neighboring base stations (e.g., using one or more receivers).

The information may include any other information which may be obtained and evaluated in order to initially configure (or subsequently adjust) the transmit power of a base station.

At step 606, the transmit power of the base station is set (or adjusted, for subsequent passes through method 600) using the obtained information. The base station transmit power may be set or adjusted using one or more of geographic distance/location information, base station signal strength information, and the like, as well as various combinations thereof. The base station transmit power may be set or adjusted using one or more empirical rules for processing the non-feedback information. In one embodiment, for example, the base station transmit power may be set or adjusted in a manner attempting to balance service coverage with transmit signal interference. The base station transmit power may be set or adjusted using various other types of information which may be processed in various other ways.

At step 608, a determination is made as to whether or not feedback information is available. If feedback information is available, method 600 proceeds to step 610, at which point method 400 of FIG. 4 may be initiated to provide base station transmit power adjustments using feedback information. If feedback information is not available, method 600 returns to step 604, (i.e., the process of using non-feedback information to adjust base station transmit power may be repeated until feedback information becomes available). In one embodiment, in which feedback information is not expected to be used to adjust base station transmit power, method 600 may return directly from step 606 to step 604 (i.e., step 608 is eliminated).

As described herein, situations may arise in which a base station may be expected to support wireless communications immediately (e.g., where the base station is deployed in an emergency network, immediately upon arriving at the scene of the emergency); however, in some situations, feedback and non-feedback information may be unavailable (or at least not yet available at the time at which the base station is activated). In one embodiment, in the absence of feedback information and non-feedback information which may be used to initially configure the transmit power of a base station, the transmit power of a base station may be initially configured depending on whether or not the base station is being activated in the vicinity of other base stations.

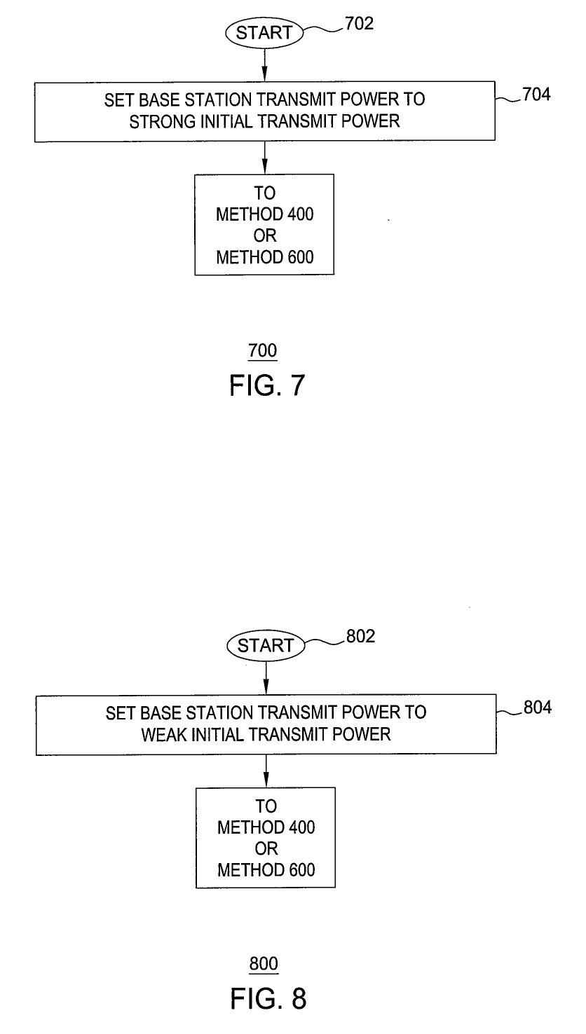

In one embodiment, in which the base station is not activated in the vicinity of any other base stations, the transmit power of the base station may be initially configured to be very strong (e.g., the transmit power of the base station may be set to the maximum possible transmit power the base station is capable of supporting). As one example associated with a rapidly-deployable network, a base station may arrive at a location at which no other base stations are currently operating (e.g., the vehicle transporting that base station is first to arrive at the scene of the emergency). A method according to one such embodiment is depicted and described with respect to FIG. 7.

In one embodiment, in which the base station is activated in the vicinity of one or more other base stations, the transmit power of the base station may be initially configured to be very weak. As one example associated with a rapidly-deployable network, a base station may arrive at a location at which other base stations are currently operating (e.g., the vehicle transporting that base station arrives at the scene of the emergency after a rapidly deployable network is already established). A method according to one such embodiment is depicted and described with respect to FIG. 8.

FIG. 7 depicts a method according to one embodiment of the present invention. Specifically, method 700 of FIG. 7 includes a method for configuring the transmit power of a base station when that base station is the first base station activated in a wireless network. Although depicted and described as being performed serially, at least a portion of the steps of method 700 of FIG. 7 may be performed contemporaneously, or in a different order than depicted and described with respect to FIG. 7. The method 700 begins at step 702 and proceeds to step 704.

At step 704, the transmit power of the base station is set to a strong initial transmit power. For example, the transmit power of the base station may be set to the maximum power with which that base station is capable of transmitting, or at least a large transmit power relative to the maximum power with which that base station is capable of transmitting or relative to one or more other factors. Since this is the only base station in the network, a large transmit power will not interfere with any existing base stations and will enable the base station to serve as many wireless user devices as possible. From step 704, method 700 proceeds to either method 400 of FIG. 4 or method 600 of FIG. 6, which is then performed in order to adjust the transmit power of the base station.

Although omitted for purposes of clarity, in one embodiment, before proceeding to method 400 of FIG. 4 or method 600 of FIG. 6, one or more other base stations may be activated in the vicinity of the first base station before any non-feedback or feedback information is available by which the first base station can determine a base station transmit power adjustment. In this embodiment, the transmit power of the first base station may be lowered to prevent interference with the newly activated/arriving base station(s). For example, the base station transmit power may be lowered by a predetermined amount or percentage. In one further embodiment, after non-feedback and/or feedback information becomes available, the each of the base stations may then begin executing method 400 of FIG. 4 and/or method 500 of FIG. 5.

FIG. 8 depicts a method according to one embodiment of the present invention. Specifically, method 800 of FIG. 8 includes a method for initially configuring the transmit power of a base station when that base station joins an existing wireless network in which one or more other base stations are already active. Although depicted and described as being performed serially, at least a portion of the steps of method 800 of FIG. 8 may be performed contemporaneously, or in a different order than depicted and described with respect to FIG. 8. The method 800 begins at step 802 and proceeds to step 804.

At step 804, the transmit power of the base station is set to a weak initial transmit power. For example the transmit power of the base station may be set to the minimum non-zero transmit power supported by the base station, or at least a small transmit power relative to the maximum power with which that base station is capable of transmitting or relative to one or more other factors). Since this base station is entering an existing network in which other base stations are already transmitting, a small transmit power will not interfere with any of the existing base stations, thereby enabling the base station to operate in the network, without impacting the performance of neighboring base stations, until an optimum transmit power of the base station can be determined (relative to the existing base stations). From step 804, method 800 proceeds to either method 400 of FIG. 4 or method 600 of FIG. 6, which is then performed in order to adjust the transmit power of the base station.

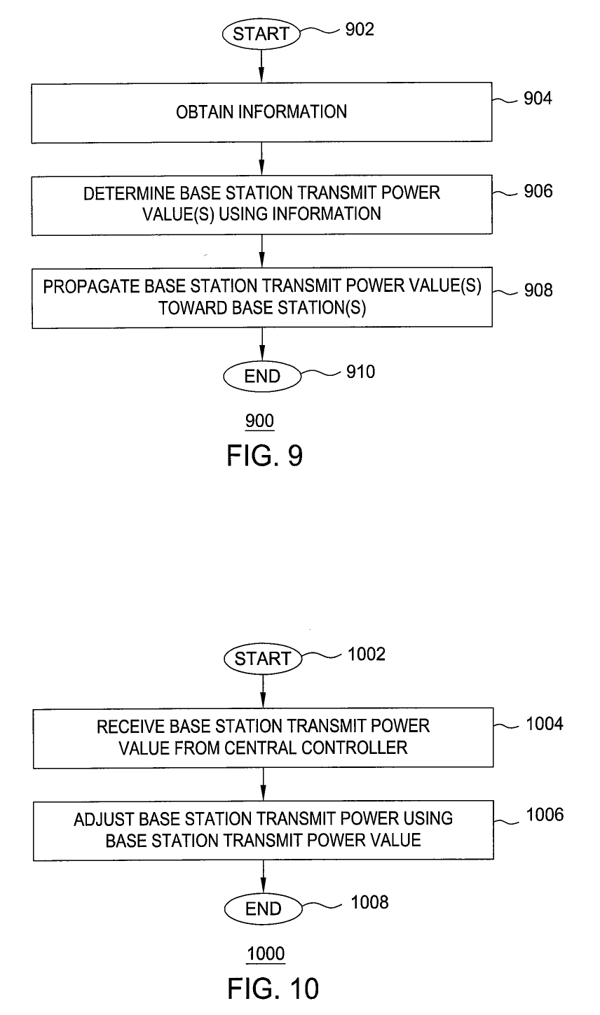

Although primarily depicted and described with respect to a distributed approach in which each base station determines its own base station transmit power adjustment (or initial configuration) values (e.g., using information obtained locally by the base station, information received from other base stations, information received from a central controller, and the like), in one embodiment a central controller may compute base station transmit power adjustment/configuration values and distribute the base station transmit power adjustment/configuration values to the respective base stations for which the base station transmit power adjustment/configuration values are computed. An embodiment of the centralized approach is depicted and described with respect to FIG. 9 and FIG. 10.

FIG. 9 depicts a method according to one embodiment of the present invention. Specifically, method 900 includes a method for determining base station transmit power values for base stations and distributing the base station transmit power values to the base stations. The method 900 of FIG. 9 may be used in conjunction with method 1000 of FIG. 10 in an embodiment in which base station transmit power configurations/adjustments are centrally controlled. Although depicted and described as being performed serially, at least a portion of the steps of method 900 of FIG. 9 may be performed contemporaneously, or in a different order than depicted and described with respect to FIG. 9. The method 900 begins at step 902 and proceeds to step 904.

At step 904, information is obtained. The information may include any information which may be used in determining base station transmit power values for base stations (e.g., feedback and/or non-feedback information). At step 906, base station transmit power values are determined for one or more base stations of the network using the obtained information. The base station transmit power values may be determined in any manner described herein. The base station transmit power values may be pre-determined values or computed values (or a mix), depending on whether or not pilot signal strength measurement information is obtained. At step 908, the base station transmit power values are propagated toward the base stations for which the base station transmit power values were determined. At step 910, method 900 ends.

FIG. 10 depicts a method according to one embodiment of the present invention. Specifically, method 1000 of FIG. 10 includes a method for receiving a base station transmit power value from a central controller and adjusting base station transmit power according to the base station transmit power value. Although depicted and described as being performed serially, at least a portion of the steps of method 1000 of FIG. 10 may be performed contemporaneously, or in a different order than depicted and described with respect to FIG. 10. The method 1000 of FIG. 10 may be used in conjunction with method 900 of FIG. 9 in an embodiment in which base station transmit power configurations/adjustments are centrally controlled. The method 1000 begins at step 1002 and proceeds to step 1004.

At step 1004, a base station receives a base station transmit power value from a central controller (e.g., another base station operating as a transmit power controller, a management system, and the like). At step 1006, the transmit power of the base station is adjusted using the received base station transmit power value (e.g., by a predetermined amount, to a computed value, and the like, depending on the value that is received from the central controller). The base station transmit power may be adjusted using any means of adjusting the transmit power of a base station (e.g., using an internal power source or power booster, an external power source or power booster, and the like, as well as various combinations thereof). At step 1008, method 1000 ends.

Although primarily depicted and described with respect to performing base station transmit power adjustments independent of coverage, in one embodiment, base station transmit power adjustments may be performed while taking into account coverage. In one embodiment, base station transmit power adjustments of the present invention may be performed in a manner which prevents any drop in coverage, or at least prevents any significant drop in coverage. In one embodiment, base station transmit power adjustments of the present invention may be performed such that a balance between quality of service and coverage may be controlled. For example, where execution of one or more base station transmit power adjustments is expected to increase the minimum per-user rate in the network at the expense of producing a corresponding decrease in coverage, the present invention may evaluate the increase in the minimum per-user rate in the network with respect to the expected decrease in coverage, and act accordingly.

In this example, the present invention may determine that the drop in coverage is insignificant compared to the expected increase in quality of service (obtained by the increase in the minimum per-user rate) and execute the base station transmit power adjustment(s). Alternatively, in this example, the present invention may determine that the drop in coverage is significant compared to the expected increase in quality of service and either choose not to execute the base station transmit power adjustment(s), or to execute different base station transmit power adjustment(s) which may strike a more desirable balance between the quality of service and coverage factors.

In other words, the base station transmit power adjustment functions of the present invention may be adapted to control base station transmit power in a manner which accounts for corresponding changes in coverage that may result from such control of base station transmit power.

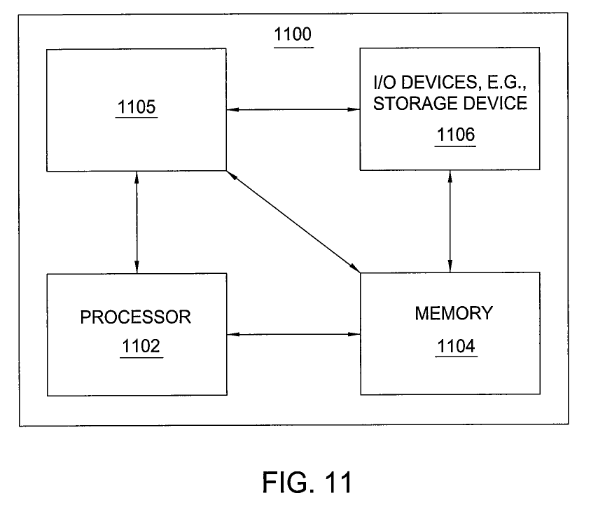

FIG. 11 depicts a high-level block diagram of a general-purpose computer suitable for use in performing the functions described herein. As depicted in FIG. 11, system 1100 comprises a processor element 1102 (e.g., a CPU), a memory 1104, e.g., random access memory (RAM) and/or read only memory (ROM), a transmit power adjustment module 1105, and various input/output devices 1106 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present transmit power adjustment process 1105 can be loaded into memory 1104 and executed by processor 1102 to implement the functions as discussed above. As such, transmit power adjustment process 1105 (including associated data structures) of the present invention can be stored on a computer readable medium or carrier, e.g., RAM memory, magnetic or optical drive or diskette, and the like.

Although primarily depicted and described herein with respect to using rapidly deployable nodes (such as 911-NOW nodes depicted and described herein) to deploy a wireless network in emergency response situations, rapidly deployable nodes may be used to deploy a wireless network in various other situations. In one embodiment, rapidly deployable nodes may be used in large-crowd environments. For example, rapidly deployable nodes may be deployed during large-crowd events, such as sporting events (e.g., in a city hosting the Super Bowl, in a city hosting the Olympics, and the like), concerts, and the like. In one embodiment, rapidly deployable nodes may be used as a rapid replacement network for commercial cellular networks (i.e., to replace existing network infrastructure while such infrastructure is unavailable). In one embodiment, rapidly deployable nodes may be used in military environments (e.g., to form a rapidly deployable network on the battlefield or in other situations).

Therefore, rapidly deployable nodes according to the present invention are useful for various other applications in addition to emergency response applications, and, thus, may be deployed in various other situations in addition to emergency situations. Thus, the term “emergency site”, which is used herein to denote the geographical location in which one or more rapidly deployable nodes may be deployed to form a wireless network, may be more commonly referred to as a “network site” (i.e., the site at which the rapidly deployable wireless network is deployed to support wireless communications). Similarly, other terms primarily associated with emergency applications may be referred to more generally depending upon the application in which rapidly deployable nodes are deployed. In other words, any number of rapidly deployable nodes according to the present invention may be deployed to any geographical location to form a wireless network for any reason.

Furthermore, although primarily depicted and described herein with respect to rapidly deployable wireless networks, the present invention may be used to adjust transmit power for any type of base station deployed in any type of wireless network. Moreover, although primarily depicted and described herein with respect to adjusting transmit power for base stations, the present invention may be used to adjust transmit power for any type of wireless transmission equipment. Thus, the present invention is not intended to be limited by the type of wireless network or type of wireless transmission equipment depicted and described herein.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for adjusting a transmit power of a target base station, comprising:
obtaining per-user rate metrics for the target base station and at least one other base station; and
adjusting the transmit power of the target base station using the per-user rate metrics.

2. The method of claim 1, wherein obtaining the per-user rate metric for the target base station comprises:
receiving feedback information from a plurality of wireless user devices served by the target base station; and
computing the per-user rate metric for the target base station using the received feedback information.

3. The method of claim 2, wherein the feedback information comprises at least one of data rate request information, channel state information, and pilot signal strength measurement information.

4. The method of claim 2, wherein computing the per-user rate metric comprises:
determining a date rate request value for each of the wireless user devices being served by the target base station using the feedback information; and
computing the per-user rate metric using the data rate request values.

5. The method of claim 4, wherein determining the data rate request values comprises at least one of:
receiving the data rate request values as feedback from the wireless user devices;
determining the data rate request values using channel state information received from the wireless user devices; and
determining the data rate request values using pilot signal strength information received from the wireless user devices.

6. The method of claim 4, wherein computing the per-user rate metric (C_{b}/N_{b}) using the data rate request values is performed according to C_{b}/N_{b}=1/[Σ(1/R_{ub})], where R_{ub} is the date rate request value from wireless user device u to the target base station b.

7. The method of claim 2, wherein computing the per-user rate metric comprises:
determining an average system throughput for the target base station;
determining a number of wireless user devices being served by the target base station; and
computing the per-user rate metric for the target base station using the average system throughput and the number of wireless user devices.

8. The method of claim 7, wherein the average system throughput for the target base station comprises one of a pre-determined value or a value computed using the feedback information.

9. The method of claim 1, wherein obtaining the at least one per-user rate metric for the at least one other base station comprises:
receiving the at least one per-user rate metric from the respective at least one other base station.

10. The method of claim 1, wherein obtaining the per-user rate metrics comprises:
receiving first feedback information from a plurality of wireless user devices served by the target base station;
computing the per-user rate metric for the target base station using the received first feedback information;
receiving second feedback information from each of the at least one other base stations; and
computing a per-user rate metric for each of the at least one other base station using the received second feedback information.

11. The method of claim 1, wherein adjusting the transmit power of the target base station comprises:
comparing the per-user rate metrics; and
adjusting the transmit power of the base station by a predetermined value based on the comparison of the per-user rate metrics.

12. The method of claim 1, wherein the feedback information includes pilot signal strength measurement information, wherein adjusting the transmit power comprises:
computing a transmit power value using the data rate metrics and the pilot signal strength measurement information; and
adjusting the transmit power of the base station to the computed transmit power value.

13. The method of claim 1, wherein adjusting the transmit power of the target base station comprises:
generating a control signal adapted for controlling at least one power source of the target base station.

14. An apparatus for adjusting a transmit power of a target base station, comprising:
means for obtaining per-user rate metrics for the target base station and at least one other base station; and
means for adjusting the transmit power of the target base station using the per-user rate metrics.

15. The apparatus of claim 14, wherein the means for obtaining the per-user rate metric for the target base station comprises:
means for receiving feedback information from a plurality of wireless user devices served by the target base station; and
means for computing the per-user rate metric for the target base station using the received feedback information.

16. The apparatus of claim 15, wherein the feedback information comprises at least one of data rate request information, channel state information, and pilot signal strength measurement information.

17. The apparatus of claim 15, wherein the means for computing the per-user rate metric comprises:
means for determining a date rate request value for each of the wireless user devices being served by the target base station using the feedback information; and
means for computing the per-user rate metric using the data rate request values.

18. The apparatus of claim 17, wherein the means for determining the data rate request values comprises at least one of:
means for receiving the data rate request values as feedback from the wireless user devices;
means for determining the data rate request values using channel state information received from the wireless user devices; and
means for determining the data rate request values using pilot signal strength information received from the wireless user devices.

19. The apparatus of claim 17, wherein the means for computing the per-user rate metric (C_{b}/N_{b}) using the data rate request values computes the per-user rate metric (C_{b}/N_{b}) according to C_{b}/N_{b}=1/[Σ(1/R_{ub})], where R_{ub} is the date rate request value from wireless user device u to the target base station b.

20. The apparatus of claim 15, wherein the means for computing the per-user rate metric comprises:
means for determining an average system throughput for the target base station;
means for determining a number of wireless user devices being served by the target base station; and
means for computing the per-user rate metric for the target base station using the average system throughput and the number of wireless user devices.

21. The apparatus of claim 20, wherein the average system throughput for the target base station comprises one of a pre-determined value or a value computed using the feedback information.

22. The apparatus of claim 14, wherein the means for obtaining the at least one per-user rate metric for the at least one other base station comprises:
means for receiving the at least one per-user rate metric from the respective at least one other base station.

23. The apparatus of claim 14, wherein the means for obtaining the per-user rate metrics comprises:
means for receiving first feedback information from a plurality of wireless user devices served by the target base station;
means for computing the per-user rate metric for the target base station using the received first feedback information;
means for receiving second feedback information from each of the at least one other base stations; and
means for computing a per-user rate metric for each of the at least one other base station using the received second feedback information.

24. The apparatus of claim 14, wherein the means for adjusting the transmit power of the target base station comprises:
means for comparing the per-user rate metrics; and
means for adjusting the transmit power of the base station by a predetermined value based on the comparison of the per-user rate metrics.

25. The apparatus of claim 14, wherein the feedback information includes pilot signal strength measurement information, wherein the means for adjusting the transmit power comprises:
means for computing a transmit power value using the data rate metrics and the pilot signal strength measurement information; and
means for adjusting the transmit power of the base station to the computed transmit power value.

26. The apparatus of claim 14, wherein the means for adjusting the transmit power of the target base station comprises:
means for generating a control signal adapted for controlling at least one power source of the target base station.

27. A method for adjusting a transmit power of a target base station, comprising:
receiving feedback information from a plurality of wireless user devices served by the target base station;
computing a per-user rate metric for the target base station using the received feedback information;
receiving at least one per-user rate metric for at least one other base station; and
adjusting the transmit power of the target base station using the per-user rate metrics.

28. A method for setting a transmit power of a base station, comprising:
obtaining information associated with the target base station and at least one other base station, wherein the obtained information comprises at least one of: geographic distance information indicative of geographic distances between the target base station and each of the at least one other base station, and base station signal power information indicative of signal power measured at the target base station based on signals received from each of the at least one other base station; and
setting the transmit power of the base station using the obtained information.
